(19) United States
(12) Patent Application Publication
(10) Pub. No.: US 2022/0072557 A1
(43) Pub. Date: Mar. 10, 2022

(54) ASSAY SAMPLE CARDS AND ADAPTORS AND USE OF THE SAME (II)

(71) Applicant: Essenlix Corporation, Monmouth Junction, NJ (US)

(72) Inventors: Stephen Y. CHOU, Princeton, NJ (US); Wei DING, Princeton, NJ (US); Ji QI, Hillsborough, NJ (US)

(73) Assignee: Essenlix Corporation, Monmouth Junction, NJ (US)

(21) Appl. No.: 17/416,728

(22) PCT Filed: Feb. 14, 2020
(86) PCT No.: PCT/US2020/018274

§ 371 Date: Jun. 21, 2021

Related U.S. Application Data
(60) Provisional application No. 62/782,835, filed on Dec. 20, 2018.

(51) Int. Cl. B01L 9/00

(52) U.S. Cl. CPC B01L 9/52; B01L 2200/025; B01L 2300/043; B01L 2300/0816; B01L 2200/087

(57) ABSTRACT

A device for sample analysis, including: a first plate, a second plate, spacers, a hinge, and an adhesive, wherein the first plate and the second plate are connected by the hinge and movable relative to each other around the axis of the hinge into different configurations, including an open configuration and a closed configuration as disclosed herein. Also disclosed are a kit, a system, and a method including the device.

### CROSS REFERENCE

This application is a National Stage entry (§ 371) application of International Application No. PCT/US2020/018274, filed on Feb. 14, 2020, which claims the benefit of priority to U.S. Provisional Application No. 62/782,835, filed Dec. 20, 2018, which is incorporated in its entirety.

### FIELD

Among other things, the present invention is related to devices and methods of sample holders that facilitate biological and chemical assays and use of the same.

### BACKGROUND

To facilitate biological and chemical assaying (e.g. diagnostic testing), it often needs to a sample holder that is simple to operate, compact in size, and low in cost.

For a sample holder that comprises two plates where a sample for an analysis is sandwiched between the two plates, in some cases, the two plates are stacked together before a sample is deposited, and they need to be separated when loading a sample. In certain cases, the two plates stacked together is hard to separate by hands, particularly in the case that one or both plate is very thin. In certain cases, in depositing a sample onto the plates, it needs to have one hand to deposit the sample and another hand to hold both plates, which can be very difficult. Therefore, there is a need to reduce these difficulties. Furthermore, there are need to make the sample holder simple to make and low in cost.

One objective of the present invention is to provide sample holders that are easy to separate between to stacked plates, easy to handle by one hand while loading a sample, easy to fabricate, and/or low in cost.

### SUMMARY

The following brief summary is not intended to include all features and aspects of the present invention, nor does it imply that the invention must include all features and aspects discussed in this summary.

Among other things, the present invention is related to devices and methods of sample holders that facilitate biological and chemical assays, and use of the same. Particularly, the present invention is related to an assay sample holder (also termed “card”) that comprises two plates that are movable relative to each other and that can sandwich a sample between the two plates. In some embodiments, there are spacers placed between the plates to regulate the final sample thickness, and in some embodiments, there are no spacers being used.

One objective of the present invention is to provide sample holders that are easy to separate them when the plates are stacked two plates, easy to handle by one hand while loading a sample, easy to fabricate, and/or low in cost.

Another objective of the present invention is to ensure the two plates stay together when they are insert into a slot of an adaptor for analyzing the sample sandwiched between the two plates.

The present invention provides angle self-maintaining hinges, notch of the card edges, recessed edges, adhesives, and others, to make sample handling simple, easy, fast by hands, and the sample cards cost low.

The present invention offers particular advantages to (a) the plates' thickness very thin in down to 1 um (micron) thick (or both of the plates of ˜25 um thick), (b) small area size which is not easy to handle by hands (e.g. the plate is 1 to 2 cm wide and a few cm long).

Another aspect of the present invention is to provide an adhesive that can adhere the plates to each other and prevent the inadvertent separation thereof.

Another aspect of the present invention is to provide an adhesive that does not interfere with the regulation of the sample and sample thickness by the spacers.

Another aspect of the present invention is to provide an adhesive that is removably attachable, or re-adherable, to the plates such that the adhesive can be selectively removed and attached.

One aspect of the present invention is to have a hinge that connect two or more plates together, so that the plates can open and close in a similar fashion as a book.

Another aspect of the present invention is to configure the material of the hinge, such that the hinge can self-maintain the angle between the plates after adjustment.

Another aspect of the present invention is to configure the material of the hinge, which maintain the QMAX card in the closed configuration, such that the entire QMAX card can be slide in and slide out a card slot without causing accidental separation of the two plates.

Another aspect of the present invention is to provide opening mechanisms such as but not limited to notches on plate edges or strips attached to the plates, making is easier for a user to manipulate the positioning of the plates, such as but not limited to separating the plates of by hand.

Another aspect of the present invention is to provide a hinge that can control the rotation of more than two plates.

### BRIEF DESCRIPTION OF THE DRAWINGS

The skilled artisan will understand that the drawings, described below, are for illustration purposes only. The drawings are not intended to limit the scope of the present teachings in any way. The drawings not are not entirely in scale. In the figures that present experimental data points, the lines that connect the data points are for guiding a viewing of the data only and have no other means.

FIG. 1 shows top and sectional views of an exemplary embodiment of a QMAX card with a notch, which serves as an opening mechanism. Panel (A) shows a top view of the QMAX card in a closed configuration; panel (B) shows a sectional view of the QMAX card in the closed configuration, before an external force F switches the plates from the closed configuration to the open configuration; panel (C) shows a sectional view of the QMAX card in the open configuration, where the first plate and the second plate form an angle θ after the external force F is removed.

FIG. 2 shows an exemplary embodiment of the QMAX card and an adapter that is configured to accommodate the QMAX card and measure the sample in the QMAX card.

FIG. 3 shows the top views of four exemplary embodiments of the QMAX card comprising one or more notches on its one or more notched edges.

FIG. 4 shows two exemplary embodiments of the QMAX card (QMAX device with hinge). Panel (A) shows the top view of a QMAX card that comprises one hinge in the closed configuration; panel (B) shows the top view of a QMAX card that comprises two hinges in the closed configuration; panel (C) of shows a sectional view of the QMAX card in a closed configuration; panel (D) shows a sectional view of the QMAX card in an open configuration.

FIG. 5 shows two exemplary embodiments of the QMAX card. Panel (A) shows the top view of a QMAX card that comprises one hinge in the closed configuration; panel (B) shows the top view of a QMAX card that comprises two hinges in the closed configuration; panel (C) of shows a sectional view of the QMAX card in a closed configuration; panel (D) shows a sectional view of the QMAX card in an open configuration.

FIG. 6 shows perspective and sectional views of a multi-plate/filter embodiment of a QMAX card. Panel (A) illustrates a perspective view of the QMAX card with more than two plates/filters, which are connected by a hinge that includes more than two leaves; panel (B) illustrates a sectional view of the QMAX card, demonstrating the connection between the hinge and the plates/filters.

FIG. 7 shows an embodiment of a QMAX (Q: quantification; M: magnifying; A: adding reagents; X: acceleration; also known as compressed regulated open flow (CROF)) device, which comprises a first plate and a second plate. Panel (A) shows the perspective view of the plates in an open configuration when the plates are separated apart; panel (B) shows the perspective view and a sectional view of depositing a sample on the first plate at the open configuration; panel (C) the perspective view and a sectional view of the QMAX device in a closed configuration.

FIG. 8 shows an embodiment of a QMAX device, which comprises a first plate, a second plate and a third plate. Panel (A) shows the perspective view of the plates in an open configuration when the plates are separated apart; panel (B) shows the sectional view of the plates at the open configuration.

FIG. 9 shows a cross-sectional view of two exemplary embodiments of a hinge. Panel (A) shows a hinge that has the design as shown in FIG. 2; panel (B) shows a hinge 103 that has the design as shown in FIG. 3.

FIG. 10 shows the top views of two exemplary embodiments of the QMAX card, which comprises a strip as an opening mechanism. Panel (A) illustrates the top view of an embodiment with a short strip that protrudes from one side the plates; panel (B) illustrates the top view of an embodiment with a long strip that protrudes from two side the plates.

FIG. 11 shows two exemplary embodiments of the QMAX device, which comprises an anti-overflow trench and anti-overflow wall on one of the plates, respectively.

FIG. 12 shows the prospective and sectional views of an exemplary embodiment of the QMAX card, where there is an anti-overflow trench on one of the plates.

FIG. 13 shows schematically the structure of an exemplary sample slider holding a QMAX device (left: perspective view, center: top view with inside details, right: cross-sectional view of section dd′).

FIG. 14 is a schematic illustration of the movable arm switching between two pre-defined stop positions according to some exemplary embodiments.

FIG. 15 shows schematically special corner shape helps ensure the correct insertion direction of the QMAX card into the sample slider according to some exemplary embodiments.

FIGS. 16A and 16B show top views and specific dimensions of an exemplary embodiment of the QMAX card.

FIGS. 17A and 17B show perspective views of the QMAX device in an open configuration and a closed configuration, respectively, with the adhesive, according to one embodiment of the present invention.

FIGS. 18A and 18B show perspective views of the QMAX device in an open configuration and a closed configuration, respectively, with the adhesive, according to another embodiment of the present invention.

FIGS. 19A and 19B show perspective views of the QMAX device in an open configuration and a closed configuration, respectively, with the adhesive, according to yet another embodiment of the present invention.

### DETAILED DESCRIPTION OF EXEMPLARY EMBODIMENTS

The following detailed description illustrates some embodiments of the invention by way of example and not by way of limitation. The section headings and any subtitles used herein are for organizational purposes only and are not to be construed as limiting the subject matter described in any way. The contents under a section heading and/or subtitle are not limited to the section heading and/or subtitle, but apply to the entire description of the present invention.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed.

### Definitions

As used here, the term “compressed open flow (COF)” refers to a method that changes the shape of a flowable (or deformable) sample deposited on a plate by (i) placing other plate on top of at least a part of the sample and (ii) then compressing the sample between the two plates by pushing the two plates towards each other; wherein the compression reduces a thickness of at least a part of the sample and makes the sample flow into open spaces between the plates. The term “compressed regulated open flow” or “CROF” (or “self-calibrated compressed open flow” or “SCOF” or “SCCOF”) (also known as QMAX) refers to a particular type of COF, wherein the final thickness of a part or entire sample after the compression is “regulated” by spacers, wherein the spacers are placed between the two plates. Here the CROF device is used interchangeably with the QMAX card.

The term “spacers” or “stoppers” refers to, unless stated otherwise, the mechanical objects that set, when being placed between two plates, a limit on the minimum spacing between the two plates that can be reached when compressing the two plates together. Namely, in the compressing, the spacers will stop the relative movement of the two plates to prevent the plate spacing becoming less than a preset (i.e. predetermined) value.

The term “QMAX card” refers, as used in the disclosure, two plates to sandwich a sample, either use spacers or do not use spacers in controlling sample thickness.

The terms “CROF Card (or card)”, “COF Card”, “QMAX-Card”, “Q-Card”, “CROF device”, “COF device”, “QMAX-device”, “CROF plates”, “COF plates”, and “QMAX-plates” are interchangeable, except that in some embodiments, the COF card does not comprise spacers; and the terms refer to a device that comprises a first plate and a second plate that are movable relative to each other into different configurations (including an open configuration and a closed configuration), and that comprises spacers (except some embodiments of the COF) that regulate the spacing between the plates. The term “X-plate” refers to one of the two plates in a CROF card, wherein the spacers are fixed to this plate. More descriptions of the COF Card, CROF Card, and X-plate are described in the provisional application Ser. No. 62/456,065, filed on Feb. 7, 2017, which is incorporated herein in its entirety for all purposes.

The term “direct contact” of the first and second plates refers to that the inner surfaces of the first and second plates are in direct contact, and the relative angle between the plates is zero or about zero.

The term “contact through spacer” of the first and second plates refers to that the inner surfaces of the first and second plates are in direct contact to at least a spacer that is between the plates, and the relative angle between the plates is zero or about zero, wherein a spacer is a a material that is between the plates and can determine the spacing between the plates.

The term “contact through sample” of the first and second plates refers to that the inner surfaces of the first and second plates are in direct contact to a sampler that is between the plates, and the relative angle between the plates is zero or about zero.

The term “a spacer has a predetermined height” and “spacers have a predetermined inter-spacer distance” means, respectively, that the value of the spacer height and the inter spacer distance is known prior to a QMAX process. It is not predetermined, if the value of the spacer height and the inter-spacer distance is not known prior to a QMAX process. For example, in the case that beads are sprayed on a plate as spacers, where beads are landed at random locations of the plate, the inter-spacer distance is not predetermined. Another example of not predetermined inter spacer distance is that the spacers moves during a QMAX processes.

The term “a spacer is fixed on its respective plate” in a QMAX process means that the spacer is attached to a location of a plate and the attachment to that location is maintained during a QMAX (i.e. the location of the spacer on respective plate does not change) process. An example of “a spacer is fixed with its respective plate” is that a spacer is monolithically made of one piece of material of the plate, and the location of the spacer relative to the plate surface does not change during the QMAX process. An example of “a spacer is not fixed with its respective plate” is that a spacer is glued to a plate by an adhesive, but during a use of the plate, during the QMAX process, the adhesive cannot hold the spacer at its original location on the plate surface and the spacer moves away from its original location on the plate surface.

The term “open configuration” of the two plates in a QMAX process means a configuration in which the two plates are either partially or completely separated apart and the spacing between the plates is not regulated by the spacers

The term “closed configuration” in a QMAX card process that is regulated by the spacers, means a configuration in which the plates are facing each other, the spacers and a relevant volume of the sample are between the plates, the relevant spacing between the plates, and thus the thickness of the relevant volume of the sample, is regulated by the plates and the spacers, wherein the relevant volume is at least a portion of an entire volume of the sample. The QMAX card process that is the not regulated by the spacers means that the two plates are in direct contract or indirect contact through the sample.

The term “a sample thickness is regulated by the plate and the spacers” in a QMAX process means that for a give condition of the plates, the sample, the spacer, and the plate compressing method, the thickness of at least a port of the sample at the closed configuration of the plates can be predetermined from the properties of the spacers and the plate.

The term “inner surface” or “sample surface” of a plate in a QMAX card refers to the surface of the plate that touches the sample, while the other surface (that does not touch the sample) of the plate is termed “outer surface”.

The term “height” or “thickness” of an object in a QMAX process refers to, unless specifically stated, the dimension of the object that is in the direction normal to a surface of the plate. For example, spacer height is the dimension of the spacer in the direction normal to a surface of the plate, and the spacer height and the spacer thickness means the same thing.

The term “area” of an object in a QMAX process refers to, unless specifically stated, the area of the object that is parallel to a surface of the plate. For example, spacer area is the area of the spacer that is parallel to a surface of the plate.

The term “angle self-maintain”, “angle self-maintaining”, or “rotation angle self-maintaining” refers to the property of the hinge, which substantially maintains an angle between the two plates, after an external force that moves the plates from an initial angle into the angle is removed from the plates.

### 1. QMAX Assay Device with Adhesive to Prevent Inadvertent Separation of the Plates when in a Closed Configuration

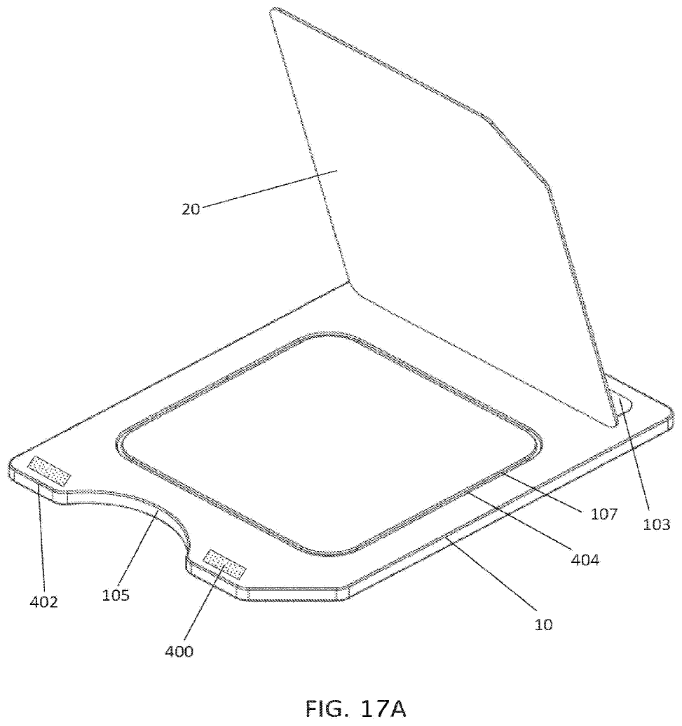

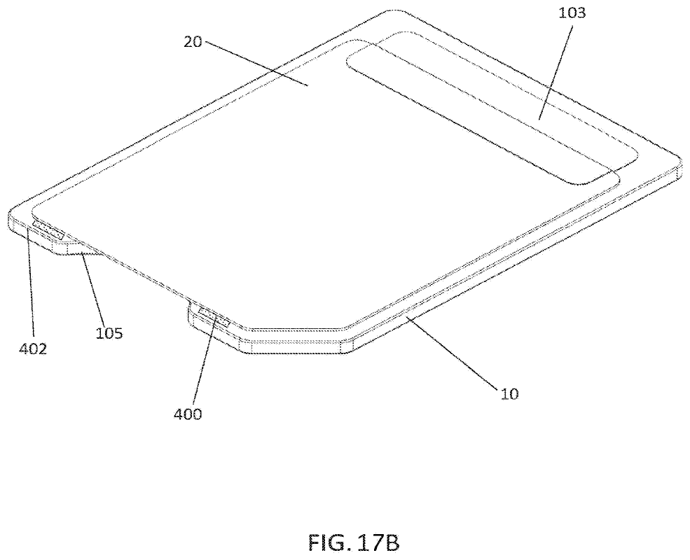

Referring now to FIGS. 17A and 17B, FIGS. 18A and 18B, and FIGS. 19A and 19B there are shown perspective views of QMAX device in an open configuration and a closed configuration, respectively, with an adhesive according to alternative embodiments of the present invention. In one embodiment of the present invention, the first plate 10 includes an adhesive 400 configured to adhere the first plate 10 and the second plate 20 to each other when in a closed configuration to prevent the inadvertent separation of the plates 10, 20 when handling or while inserted into the adaptor. In some embodiments, the adhesive 400 is disposed adjacent the edge 402 of the first plate 10 where the notch 105 is disposed, e.g., the edge opposite the hinge 103, as shown in FIGS. 17A and 17B. In this way, when the plates 10, 20 are moved into the closed configuration, the second plate adheres to the first plate 10 via the adhesive 400. In one embodiment, the adhesive 400 is disposed partially along the length of the edge 402 of the first plate 10. In another embodiment, the adhesive 400 is disposed along the entire length of the edge 402, except at the portion where the notch 105 is disposed.

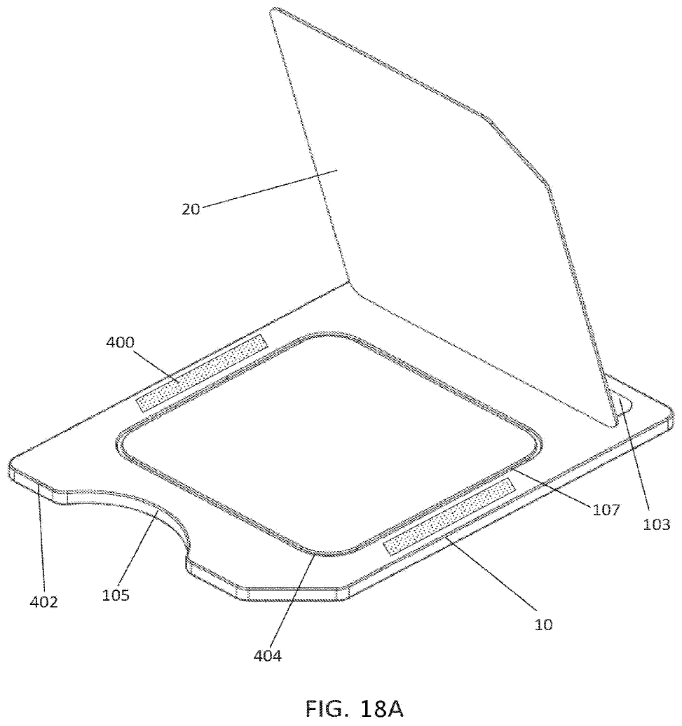

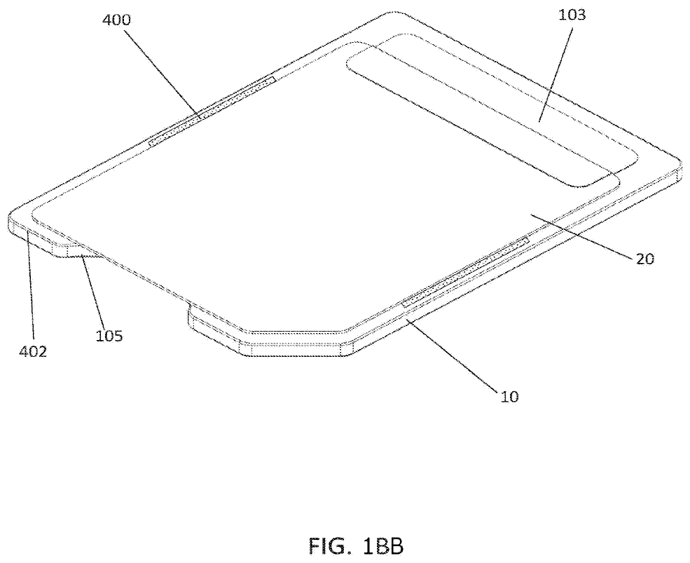

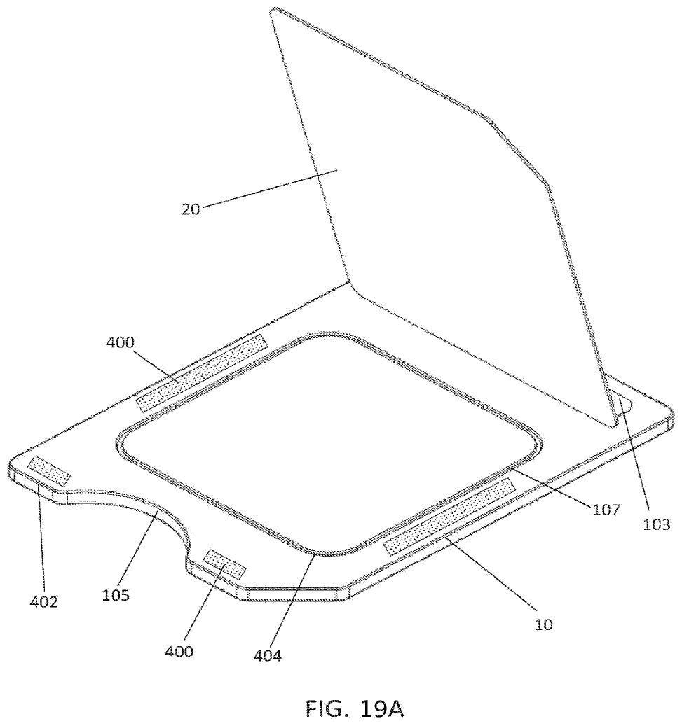

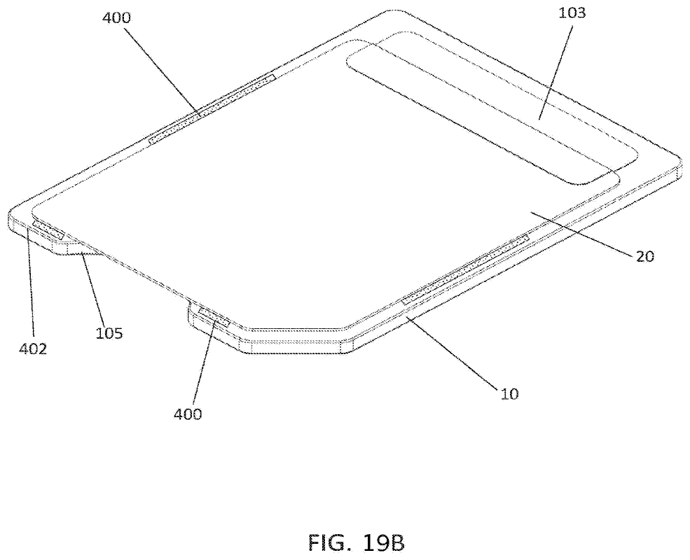

In some embodiments, the adhesive 400 is disposed adjacent an outer periphery edge 404 of the drain anti-overflow trench 107. In one embodiment, the adhesive 400 is disposed on opposing sides of the drain anti-overflow trench 107 adjacent the outer periphery edge 404 of drain anti-overflow trench 107, such that the adhesive 400 extends longitudinally relative to the plates 10, 20 and is disposed between the side edges of the first plate 10 and the drain anti-overflow trench 107, as shown in FIGS. 18A and 18B. In another embodiment, the adhesive 400 is disposed adjacent the edge 402 of the first plate 10 where the notch 105 is disposed and also disposed adjacent an outer periphery edge 404 of the drain anti-overflow trench 107, as shown in FIGS. 19A and 19B. In yet another embodiment, the adhesive 400 is disposed along the entire outer periphery edge 404 of drain anti-overflow trench 107, such that the adhesive 400 surrounds the drain anti-overflow trench 107.

In some embodiments, the adhesive 400 is removably attachable, or re-adherable, to the first plate 10, such that the adhesive 400 may be peeled away (unstuck) and pressed back (re-stuck) onto the first plate 10. In alternative embodiments, the adhesive 400 is fixedly attached to the first plate 10. In some embodiments, the adhesive 400 can be glue, cement, mucilage, or paste. In some embodiments, the glue is a natural adhesive or synthetic adhesive, or from any other origin, or any combination thereof. In some embodiments, the adhesive 400 is selected from materials such as but not limited to: starch, dextrin, gelatine, asphalt, bitumin, polyisoprenenatural rubber, resin, shellac, cellulose and its derivatives, vinyl derivatives, acrylic derivatives, reactive acrylic bases, polychloroprene, styrene-butadiene, styrene-diene-styrene, polyisobutylene, acrylonitrile-butadiene, polyurethane, polysulfide, silicone, aldehyde condensation resins, epoxide resins, amine base resins, polyester resins, polyolefin polymers, soluble silicates, phosphate cements, or any other adhesive material, or any combination thereof. In some embodiments, the adhesive 400 is spontaneous-cured, heat-cured, UV-cured, or cured by any other treatment, or any combination thereof. In some embodiments, the adhesive 400 is drying adhesive, pressure-sensitive adhesive, contact adhesive, hot adhesive, or one-part or multi-part reactive adhesive, or any combination thereof. In one embodiment, the adhesive 400 is an acrylate copolymer that forms a suspension of cross-linked microspheres. In some embodiments, the adhesive 400 is an adhesive strip. In other embodiments, the adhesive 400 is an adhesive strip having a double-sided adhesive, or an adhesive on upper and lower surfaces.

In some embodiments, the adhesive 400 has a thickness that is less than or equal to the height of the spacers, such that the adhesive 400 does not interfere with the regulation of the space between the first plate 10 and the second plate 20 by the spacers. In alternative embodiments, the adhesive 400 has a thickness slightly larger than the height of the spacers (e.g., between 0-10%).

### 2. Examples of Embodiments of the Present Invention

1. Examples of Spacer, Recessed Edges, Hinge, Notch, and Adhesive
1. A device for sample analysis, comprising:

a first plate, a second plate, spacers, a hinge, and an adhesive, wherein:
i. the first plate and the second plate are connected by the hinge and movable relative to each other around the axis of the hinge into different configurations, including an open configuration and a closed configuration;
ii. each plate comprises an inner surface that has a sample contact area for contacting a sample for analysis;
iii. the first plate has a notch on an edge or a corner of the plate;
iv. in the closed configuration, a portion of an edge of the second plate is disposed over the notch, such that the second plate can be separated from first plate and lifted into the open configuration without interference by the first plate;
and
v. in the closed configuration, at least two edges of the second plate, except the portion of the edge of the second plate that is disposed over the notch, are recessed inside the edges of the first plate,
vi. the adhesive is disposed on the edge of the first plate where the notch is disposed, such that when in the closed configuration, the second plate adheres to first plate via the adhesive and the adhesive prevents the inadvertent separation of the plates,
wherein in the open configuration, the two plates are partially or entirely separated apart,
wherein the sample is deposited in the open configuration, and
wherein in the closed configuration, the inner surfaces of the two plates are in either a direct contact, a contact through a spacer, or a contact through the sample.
2. A device for sample analysis, comprising:

a first plate, a second plate, spacers, a hinge, and an adhesive, wherein:
i. the first plate and the second plate are connected by the hinge and movable relative to each other around the axis of the hinge into different configurations, including an open configuration and a closed configuration;
ii. each plate comprises an inner surface that has a sample contact area for contacting a sample for analysis;
iii. the first plate has a notch on an edge or a corner of the plate;
iv. in closed configuration, a portion of an edge of the second plate is disposed over the notch, such that the second plate can be separated from the first plate and lifted into an open configuration without interference by the first plate; and
v. in the closed configuration, all edges of the second plate, except the portion of the edge of the second plate that is disposed over the notch and except the edge with hinge are recessed inside of the edges of the first plate, wherein the hinged edge is either recessed or not recessed from the corresponding edge of the first plate,
vi. the adhesive is disposed on the edge of the first plate where the notch is disposed, such that when in the closed configuration, the second plate adheres to first plate via the adhesive and the adhesive prevents the inadvertent separation of the plates,
wherein in the open configuration, the two plates are partially or entirely separated apart;
wherein the sample is deposited in the open configuration; and
wherein in the closed configuration, the inner surfaces of the two plates are in either a direct contact, a contact through a spacer, or a contact through the sample.

2. Examples of Notch Recess for Easy Opening
3. A device for sample analysis, comprising:

a first plate, a second plate, and an adhesive, wherein:
a. the first plate and the second plate are movable relative to each other into different configurations, including an open configuration and a closed configuration, wherein each plate comprises an inner surface that has a sample contact area for contacting a sample for analysis, and at least one of the plates has a thickness of 4 mm or less;
b. the first plate has a notch recessed from an edge or a corner of the plate; and
c. in the closed configuration, a portion of an edge of the second plate is disposed over the notch, such that the second plate can be separated from the first plate and lifted into an open configuration without interference by the first plate,
d. the adhesive is disposed on the edge of the first plate where the notch is disposed, such that when in the closed configuration, the second plate adheres to first plate via the adhesive and the adhesive prevents the inadvertent separation of the plates,
wherein in the open configuration, the two plates are partially or entirely separated apart, and the sample is deposited; and
wherein in the closed configuration, the inner surfaces of the two plates are in either a direct contact, a contact through a spacer, or a contact through the sample.

3. Examples of Angle Self Maintaining Hinge
4. A device for sample analysis, comprising:

a first plate, a second plate, a hinge, and an adhesive, wherein:
a. the first plate and the second plate are movable relative to each other into different configurations, wherein each plate respectively comprises an inner surface that has a sample contact area for contacting a sample for analysis, and at least one of the plate has a thickness of 4 mm or less; and
b. the hinge connects the first plate and the second plate, wherein (a) the hinge is configured to allow the two plates to rotate relative to each other around the hinge into the different configurations when an external rotating force is applied to the plates, (ii) in each configuration the two plates has an angle relative to each other; and (iii) the hinge is an angle self-maintaining (ASM) hinge that substantially maintain the angle, after the external rotating force is removed,
c. the adhesive is disposed on the first plate opposite the hinge,
wherein one of the configurations is an open configuration, in which the two plates are partially or entirely separated apart, and the sample is deposited;
wherein another configuration is a closed configuration, in which, the inner surfaces of the two plates are in either a direct contact, a contact through a spacer, or a contact through the sample, and in which the second plate adheres to the second plate via the adhesive such that the adhesive prevents the inadvertent separation of the plates.

4. Examples of Recessed Edges, Notch, and Recessed Edge
5 A device for sample analysis, comprising:

a first plate, a second plate, a hinge, and an adhesive, wherein:
i. the first plate and the second plate are connected by the hinge and movable relative to each other around the axis of the hinge into different configurations, including an open configuration and a closed configuration;
ii. each of the plates comprises an inner surface that has a sample contact area for contacting a sample for analysis;
iii. the second plate has a notch on an edge or a corner of the plate;
iv. in the closed configuration, at least two edges of the first plate are recessed relative to the edges of the second plate;
v. in the closed configuration, a portion of an edge of the second plate is disposed over the notch, such that the second plate can be separated from the first and lifted into an open configuration without interference by the first plate; and
vi. the adhesive is disposed on the edge of the first plate where the notch is disposed, such that when in the closed configuration, the second plate adheres to first plate via the adhesive and the adhesive prevents the inadvertent separation of the plates,
wherein in the open configuration, the two plates are partially or entirely separated apart;
wherein the sample is deposited in the open configuration; and
wherein in the closed configuration, the inner surfaces of the two plates are in either a direct contact, a contact through a spacer, or a contact through the sample.

5. Examples of Recessed Edges and Hinge
6 A device for sample analysis, comprising:

a first plate, a second plate, a hinge, and an adhesive, wherein:
i. the first plate and the second plate are connected by the hinge and movable relative to each other around the axis of the hinge into different configurations, including an open configuration and a closed configuration;
ii. each plate comprises an inner surface that has a sample contact area for contacting a sample for analysis; and
iii. in the closed configuration at least two edges of the first plate are recessed relative to the edges of the second plate;
iv. the adhesive is disposed on the edge of the first plate where the notch is disposed, such that when in the closed configuration, the second plate adheres to first plate via the adhesive and the adhesive prevents the inadvertent separation of the plates,

wherein in the open configuration, the two plates are partially or entirely separated apart;

wherein the sample is deposited in the open configuration; and
wherein in the closed configuration, the inner surfaces of the two plates are in either a direct contact, a contact through a spacer, or a contact through the sample.

### Examples of Adapter and Easy Sliding

9. A system comprising:
   (a) a device of any of prior embodiments; and
   (b) an adaptor that is configured to connect to a camera and comprises a slot, wherein
      i. the slot is dimensioned to receive the device in the closed configuration;
      ii. the slot is configured to allow the device slide in and out of the slot, and to fix the device at a position when the device slides in the slot; and
         i. the adaptor is configured to fix, after the device slides in the slot, the relative position between the device and the camera.

6. Examples of Method—Using the Kit of AA
10. A method of sample analysis, comprising:
   (a) obtaining a kit of any prior embodiments;
   (b) depositing the sample on the inner surface of one or both of the plates when the plates are at an open configuration;
   (c) turning the plates around the axis of the hinge into a closed configuration;
   (d) incubating for a predetermined period of time;
   (e) opening the plates by turning the plates around the axis of the hinge into the open configuration;
   (f) processing or analyzing the sample.

7. Examples of Drain and Hinge
11. A device for sample analysis, comprising:

a first plate, a second plate, a hinge, and an adhesive, wherein:
i. the first plate and the second plate are connected by the hinge and movable relative to each other around the axis of the hinge into different configurations, including an open configuration and a closed configuration;
ii. each plate comprises an inner surface that has a sample contact area for contacting a sample for analysis; and
ii. one or both of the plates respectively has, on the inner surface, a drain anti-overflow trench that surrounds the sample contacting area;
iii. the adhesive is disposed adjacent the drain anti-overflow trench, such that when in the closed configuration, the plates adheres to each other via the adhesive and the adhesive prevents the inadvertent separation of the plates,
wherein in the open configuration, the two plates are partially or entirely separated apart;
wherein the sample is deposited in the open configuration; and
wherein in the closed configuration, the inner surfaces of the two plates are in either a direct contact, a contact through a spacer, or a contact through the sample; and
wherein the drain anti-overflow trench is configured to prevent or reduce a sample deposited in the sample contact area when the plates are at an open configuration from flowing outside the drain anti-overflow trench when the plates are at a closed configuration.

8. Examples of Methods
12 A method for making a thin layer of a sample, comprising
   (a) depositing a sample on one or both of the sample contact areas of a device of any of any prior embodiments when the plates are configured in an open configuration,
   (b) after (a), moving the two plates around the hinge into the close configuration, wherein, in the closed configuration, at least part of the sample is compressed into a thin layer between the plates.
13 A method for making a thin layer of a sample, comprising
   (a) depositing a sample on one or both of the sample contact areas of a device of any of any prior embodiments when the plates are configured in an open configuration,
   (b) after (a), moving the two plates around the hinge into the close configuration, wherein, in the closed configuration, at least part of the sample is between the plates and the average spacing between the sample contact areas of the plates is in the range of 0.01 to 200 μm.
14. The device, kit, system, or method of any prior embodiment, wherein the adhesive is removably attachable to the plate.
15. The device, kit, system, or method of any prior embodiment, wherein the adhesive is peelable off the plate.
16. The device, kit, system, or method of any prior embodiment, wherein the adhesive is pressure sensitive.
17. The device, kit, system, or method of any prior embodiment, wherein the adhesive is selected from the group consisting of glue, cement, mucilage, or paste.
18. The device, kit, system, or method of any prior embodiment, wherein the adhesive is glue.
19. The device, kit, system, or method of any prior embodiment, wherein the adhesive is an adhesive strip.
20. The device, kit, system, or method of any prior embodiment, wherein the adhesive has a thickness that is less than or equal to the height of the spacers.
21. The device, kit, system, or method of any prior embodiment, wherein the adhesive has a thickness that is larger than the height of the spacers.
22. The device, kit, system, or method of any prior embodiment, wherein the adhesive is disposed along the entire length of the notched edge of the first plate, except the portion where the notch is disposed.
23. The device, kit, system, or method of any prior embodiment, wherein the adhesive is disposed partially along the length of the notched edge of the first plate.
24. The device, kit, system, or method of any prior embodiment, wherein the adhesive is disposed on the edge opposite the edge with the hinge.
25. The device, kit, system, or method of any prior embodiment, wherein the adhesive is disposed along an outer periphery edge of the drain anti-overflow trench.
26. The device, kit, system, or method of any prior embodiment, wherein the adhesive is disposed along the entire outer periphery edge of drain anti-overflow trench, such that the adhesive surrounds the drain anti-overflow trench.
27. The device, kit, system, or method of any prior embodiment, wherein the adhesive is disposed on opposing sides of the drain anti-overflow trench along an outer periphery edge of drain anti-overflow trench, such that the adhesive extends longitudinally relative to the plates.
28. The device, kit, system, or method of any prior embodiment, wherein the adhesive is disposed between the side edges of the first plate and the drain anti-overflow trench.
29. The device, kit, system, or method of any prior embodiments, wherein the hinge is an angle self-maintaining hinge.
30. The device, kit, system, or method of any prior embodiments, wherein further comprising:
   analyzing the sample by imaging the sample or detecting a measurable signal from the sample.
31. The device, kit, system, or method of any prior embodiments, wherein the camera is a part of a handheld mobile communication device.
32. The device, kit, system, or method of any prior embodiments, wherein the distance between the camera and the device is 10 cm or less when the device is inserted into the slot and the adaptor is connected to the camera.
33. The device, kit, system, or method of any prior embodiments, wherein, after force is removed, the hinge maintains an angle between the two plates that is within 5 degrees from the angle just before the external force is removed.
34. The device, kit, system, or method of any prior embodiments, wherein, after the external force is removed, the hinge maintains an angle between the two plates that is within 10 degrees from the angle just before the external force is removed.
35. The device, kit, system, or method of any prior embodiments, wherein after the external force is removed, the hinge maintains an angle between the two plates that is within 20 degrees from the angle just before the external force is removed.
36. The device, kit, system, or method of any prior embodiments, wherein after the external force is removed, the hinge maintains an angle between the two plates that is within 30 degrees from the angle just before the external force is removed.
37. The device, kit, system, or method of any prior embodiments, wherein the width of at least one notch is in the range of ⅙ to ⅔ of the width of the notched edge.
38. The device, kit, system, or method of any prior embodiments, wherein the width of at least one notch is in the range of 1 mm to 50 mm.
39. The device, kit, system, or method of any prior embodiments, wherein the area of overlapping part of the other plate is in the range of 1/10 to the entire area of the notch.
40. The device, kit, system, or method of any prior embodiments, wherein the area of overlapping part of the other plate is in the range of 1 mm² to 500 mm².
41. The device, kit, system, or method of any prior embodiments, wherein the opening edge of the plate without the notch is inside the notched edge except for the part over the notch.
42. The device, kit, system, or method of any prior embodiments, wherein the hinge comprises a first leaf, a second leaf, and a joint that connects the leaves and is configured for the leaves to rotate around the joint.
43. The device of embodiment C1, wherein the first leaf is attached the first plate and the second leaf is attached to the second plate.
44. The device, kit, system, or method of any prior embodiments, wherein the first leaf, the second leaf, and the joint, is made of a material that initially has a uniform thickness.
45. The device, kit, system, or method of any prior embodiments, wherein the hinge is made of a piece of hinge material of a substantially uniform thickness, wherein the hinge material is attached to a part of the inner surface of the first plate and a part of the outer surface of the second plate, and the attachments do not completely separate using operation.
46. The device, kit, system, or method of any prior embodiments, wherein the hinge is made of a piece of hinge material of a substantially uniform thickness, wherein the hinge material is attached a part of the outer surfaces of the first plate and the second plate, and the attachments do not completely separate using operation.
47. The device, kit, system, or method of any prior embodiments, wherein the hinge is a piece of hinge material of a substantially uniform thickness, wherein the hinge material is attached a part of the inner surfaces of the first plate and the second plate, and the attachments do not completely separate using operation.
48. The device, kit, system, or method of any prior embodiments, wherein the hinge material is a metal.
49. The device, kit, system, or method of any prior embodiments, wherein the hinge material is a metal, that is selected from a group consisting of: gold, silver, copper, aluminum, iron, tin, platinum, nickel, cobalt, and alloys thereof.
50. The device, kit, system, or method of any prior embodiments, wherein the metallic material is aluminum.
51. The device, kit, system, or method of any prior embodiments, wherein the length of the hinge is in the range of 1/20 to the entirety of the length of a plate edge with which the joint is aligned.
52. The device, kit, system, or method of any prior embodiments, wherein one or both of the plate is transparent.
53. The device, kit, system, or method of any prior embodiments, wherein one or both of the plate is opaque.
54. The device, kit, system, or method of any prior embodiments, wherein at least one of the plates has a thickness of less than 200 μm.
55. The device, kit, system, or method of any prior embodiments, wherein at least one of the plates has a thickness of less than 100 μm.
56. The device, kit, system, or method of any prior embodiments, wherein at least one of the plates has an area of less than 5 cm².
57. The device, kit, system, or method of any prior embodiments, wherein at least one of the plates has an area of less than 2 cm².
58. The device, kit, system, or method of any prior embodiments, wherein at least one of the plates is made from a flexible polymer.
59. The device, kit, system, or method of any prior embodiments, wherein the uniform height of the spacers is in the range of 0.5 to 100 μm and the constant inter-spacer distance of the spacers is in the range of 5 to 200 μm.
60. The device, kit, system, or method of any prior embodiments, wherein the uniform height of the spacers is in the range of 0.5 to 20 μm and the constant inter-spacer distance of the spacers is in the range of 7 to 50 μm.
61. The device, kit, system, or method of any prior embodiments, wherein the spacers are made from polystyrene, PMMA, PS, PMMG, PC, COC, COP, or another plastic, or any combinations thereof.
62. The device, kit, system, or method of any prior embodiments, wherein the spacers have a pillar shape, and a flat top surface.
63. The device of any prior embodiments, wherein the spacers have a density of at least 100/mm².
64. The device of any prior embodiments, wherein the spacers have a density of at least 1000/mm².
65. The device, kit, system, or method of any prior embodiments, wherein the first leaf and the second leaf are attached to the plates by molding or gluing.
66. The device, kit, system, or method of any prior embodiments, wherein the first leaf, the second leaf, and the joint are made of a single material that is flexible.
67. The device, kit, system, or method of any prior embodiments, wherein the hinge comprises at least a first layer and a second layer spanning across the first leaf, the second leaf and the joint.
68. The device, kit, system, or method of any prior embodiments, wherein the second layer is made from metal and the first layer is a layer of glue attaching the hinge to the first plate and the second plate.
69. The device, kit, system, or method of any prior embodiments, wherein the hinge is made of a material that can self-maintaining the relative angle of the two plates.
70. The device, kit, system, or method of any prior embodiments, wherein the hinge self-maintains the relative angle of the two plates after the external forces was removed, and the hinge is made from a metallic material, non-metallic material, or a combination, wherein the metallic material is selected from a group consisting of: gold, silver, copper, aluminum, iron, tin, platinum, nickel, cobalt, or alloys, or any other metallic material capable of providing a mechanical force that substantially maintains the angle formed by the first plate and the second plate after the angle is changed by an external force, or any combination thereof.
71. The device, kit, system, or method of any prior embodiments, wherein the glue for attaching the hinge onto the plates is made from a material selected from a group consisting of: dextrin, gelatine, asphalt, bitumin, natural rubber, resin, shellac, cellulose and its derivatives, vinyl derivatives, acrylics, reactive acrylic bases, polychloroprene, styrene-butadiene, styrene-diene-styrene, polyisobutylene, acrylonitrile-butadiene, polyurethane, polysulfide, silicone, aldehyde condensation resins, epoxy resins, amine base resins, polyester resins, polyolefin polymers, or any combination thereof.
72. The device, kit, system, or method of any prior embodiments, wherein the ASM (angle self-maintaining) hinge is made of materials of metallic, polymers or a combination, wherein: the metallic material is selected from a group consisting of: gold, silver, copper, aluminum, iron, tin, platinum, nickel, cobalt, or alloys, or any other metallic material capable of providing a mechanical force that holds the plates in the open configuration after an external force that opens the plates is removed, or any combination thereof; and the polymer material is selected from the group consisting of acrylate polymers, vinyl polymers, olefin polymers, cellulosic polymers, noncellulosic polymers, polyester polymers, Nylon, cyclic olefin copolymer (COC), poly(methyl methacrylate) (PMMBB), polycarbonate (PC), cyclic olefin polymer (COP), liquid crystalline polymer (LCP), polyimide (PBB), polyethylene (PE), polyimide (PI), polypropylene (PP), poly(phenylene ether) (PPE), polystyrene (PS), polyoxymethylene (POM), polyether ether ketone (PEEK), polyether sulfone (PES), poly(ethylene phthalate) (PET), polytetrafluoroethylene (PTFE), polyvinyl chloride (PVC), polyvinylidene fluoride (PVDF), polybutylene terephthalate (PBBT), fluorinated ethylene propylene (FEP), perfluoroalkoxyalkane (PFBB), polydimethylsiloxane (PDMS), rubbers, or any combinations of thereof.
73. The device, kit, system, or method of any prior embodiments, wherein the ASM (angle self-maintaining) hinge is a made a composition material that allows angle self-maintaining.
74. The device, kit, system, or method of any prior embodiments, wherein the ASM (angle self-maintaining) hinge has two uniform layers and the first layer and the second layer have a thickness in the range of 10-100 μm; or comprises a first leaf and a second leaf interconnected by the joint, and the first leaf and the second leaf are attached to the plates by molding;
75. The device, kit, system, or method of any prior embodiments, wherein the angle in the ASM (angle self-maintaining) is maintained with a change of less than 5 degrees after the external force is removed, or with a change of less than 10 degrees after the external force is removed.
76. The device, kit, system, or method of any prior embodiments, wherein the angle self-maintaining hinge is made of a piece of hinge material of a substantially uniform thickness, wherein the thickness is 1 um (micron), 10 um, 20 um, 50 um, 75 um, or a range between any of the two values.
77. The device, kit, system, or method of any prior embodiments, wherein the angle self-maintaining hinge is made of a piece of hinge material of a substantially uniform thickness, wherein the thickness is 75 um (micron), 100 um, 250 um, or a range between any of the two values.
78. The device, kit, system, or method of any prior embodiments, wherein the angle self-maintaining hinge is made of a piece of hinge material of a substantially uniform thickness, wherein the thickness is 200 um (micron), 500 um, 2500 um, or a range between any of the two values.
79. The device, kit, system, or method of any prior embodiments, wherein the sample thickness at a closed configuration of the two plates has thickness of 0.001 um (micron), 0.01 um, 0.1 um, 1 um, 10 um, 20 um, 50 um, or a range between any of the two values.
80. The device, kit, system, or method of any prior embodiments, wherein the sample thickness at a closed configuration of the two plates has thickness of 75 um (micron), 100 um, 250 um, or a range between any of the two values.
81. The device, kit, system, or method of any prior embodiments, wherein the sample thickness at a closed configuration of the two plates has thickness of 200 um (micron), 500 um, 2500 um, or a range between any of the two values.

### 3. QMAX Assay

In biological and chemical assaying (i.e. testing), a device and/or a method that simplifies assaying operation or accelerates assaying speed is often of great value.

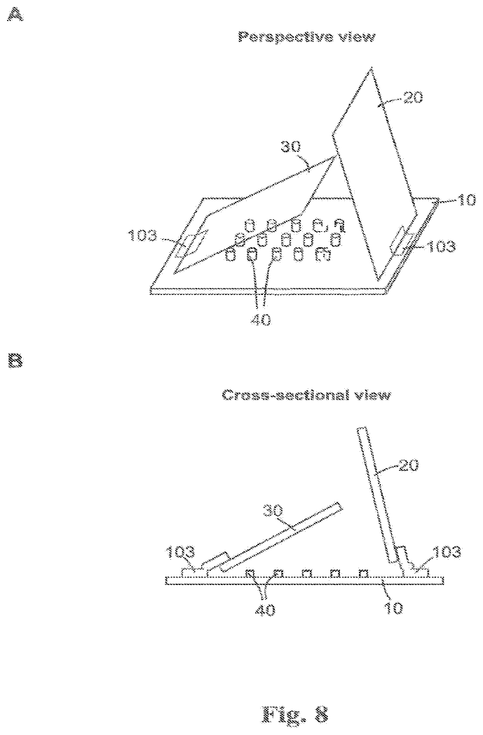

A QMAX card uses two plates to manipulate the shape of a sample into a thin layer (e.g. by compressing) (as illustrated in FIG. 8). In certain embodiments, the plate manipulation needs to change the relative position (termed: plate configuration) of the two plates several times by human hands or other external forces. There is a need to design the QMAX card to make the hand operation easy and fast.

In some embodiments of QMAX assays that use spacers, one of the plate configurations is an open configuration, wherein the two plates are completely or partially separated (the spacing between the plates is not controlled by spacers) and a sample can be deposited. Another configuration is a closed configuration, wherein at least part of the sample deposited in the open configuration is compressed by the two plates into a layer of highly uniform thickness, the uniform thickness of the layer is confined by the inner surfaces of the plates and is regulated by the plates and the spacers. In some embodiments of QMAX card, the spacers are not used.

In a QMAX assay operation, an operator needs to first make the two plates to be in an open configuration ready for sample deposition, then deposit a sample on one or both of the plates, and finally close the plates into a close position. In certain embodiments, the two plates of a QMAX card are initially on top of each other and need to be separated to get into an open configuration for sample deposition. When one of the plate is a thin plastic film (175 um thick PMA), such separation can be difficult to perform by hand. The present invention intend to provide the devices and methods that make the operation of certain assays, such as the QMAX card assay, easy and fast.

### 4. Notch for Facilitating Opening and Manipulation of QMAX Card

In using QMAX card, the two plates need to be open first for sample deposition. However, in some embodiments, the QMAX card from a package has the two plates are in contact each other (e.g. a close position), and to separate them is challenges, since one or both plates are very thing. To facilitate an opening of the QMAX card, opening notch or notches are created at the edges or corners of the first plate or both places, and, at the close position of the plates, a part of the second plate placed over the opening notch, hence in the notch of the first plate, the second plate can be lifted open without a blocking of the first plate.

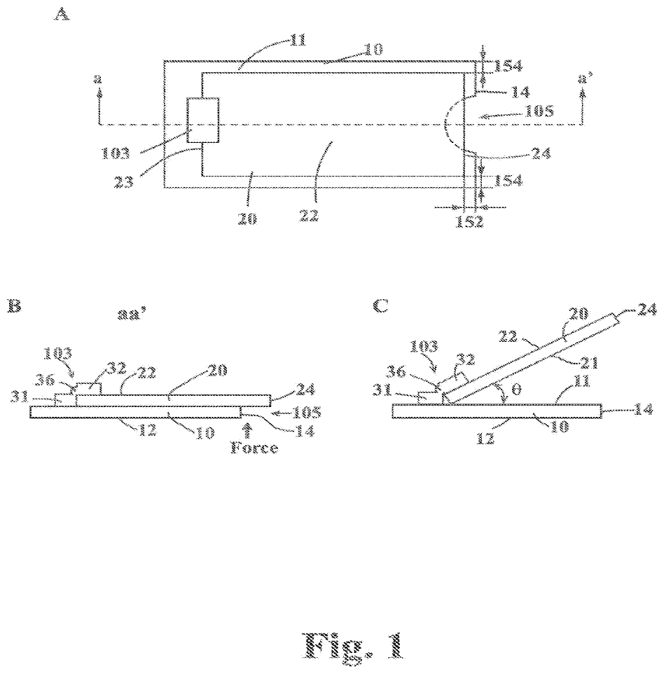

FIG. 1 shows an exemplary embodiment of a QMAX card with an opening mechanism. In particular, panel (A) shows a top view of the QMAX card in a closed configuration, where the QMAX card comprises a first plate 1, a second plate 2, and a hinge 103 that connects the first plate 10 with the second plate 2. The first plate 10 comprises an inner surface 11 and an outer surface (not shown); the second plate 20 comprises an inner surface (not shown) and an outer surface 22, wherein the first plate inner surface 11 faces the second plate inner surface in the closed configuration.

As shown in FIG. 1 panel (A), in some embodiments, the second plate 20 comprises a second plate hinge edge 23 positioned against the first plate inner surface 11. The hinge 103 is attached to the first plate inner surface 11 and second plate outer surface 22 to rotate the two plates to pivot against each other and switch between an open configuration and a closed configuration. It is also possible that the hinge 103 is positioned according to other designs. For example, in some embodiments, the hinge 103 wraps around a first plate hinge edge (not marked) aligned with the second plate hinge edge 23 to rotate the plates.

Also as shown in FIG. 1, panel (A), the first plate 10 comprises a notch 105 positioned on a notched edge 13 of the first plate 1. The second plate 20 comprises a corresponding opening edge 24 partially juxtaposed over the notch 105. Such a design allows a user of the device to push against the opening edge 24 over the notch 105 to separate the two plates from the closed configuration to an open configuration or change the angle between the first plate 10 and the second plate 20 when the two plates are in the open configuration.

One example of the notch advantage is in the case the QMAX card is operated by hands. Without a notch would be difficult to separate the two plates at a closed configuration. With the notch of the first plate and a portion of the second plate edge is over the notch, one can lift open the second plate from the closed configuration using his/her figures rather easily, since at the notch, a part or whole finger touches only the second plate not the first plate.

FIG. 1 panel (A) shows a notch 105 with a semicircle shape. However, it should be noted that the notch 105 is any shape as long as an opening is provided in the first plate 10 beneath the second plate 20 to facilitate opening the first plate 10 and second plate 2. For example, the notch 105 has a shape of any part of a circle. In some embodiments, the notch 105 has the shape of part or all of a square, rectangle, triangle, hexagon, polygon, trapezoid, sector-shape or any combinations of thereof.

The size of the notch 105 is adjusted according to the size of the plates and the specific needs of the user. For example, the length of the notch 105, which is defined as the length of the widest opening on the notched edge 13, is less than 1 mm, 2.5 mm, 5 mm, 10 mm, 15 mm, 20 mm, 25 mm, 30 mm, 40 mm, 50 mm, or in a range between any of the two values. In some embodiments, the length of the notch 105 is less than 1/10, 1/9, 1/7, ⅙, ⅕, ¼, ⅓, ⅖, ½, ⅗, ⅔, ¾, ⅘, ⅚, or 9/10 of the length of the notched edge, or in a range between any of the two values. In some embodiments, when the notch 105 is in the shape of part of a circle, such a circle has a radius of less than 1 mm, 2.5 mm, 5 mm, 10 mm, 15 mm, 20 mm, 25 mm, 30 mm, 40 mm, 50 mm, or in a range between any of the two values. In some embodiments, the notch has an average lateral dimension less than 1 mm, 2.5 mm, 5 mm, 10 mm, 15 mm, 20 mm, 25 mm, 30 mm, 40 mm, 50 mm, or in a range between any of the two values.

As shown in FIG. 1, panel (A), the opening edge 24 of the second plate 20 is partially juxtaposed over the notch 105 of first plate 1. In other words, the second plate 20 does not cover the notch 105 in its entirety. In other embodiments, however, it is possible that the notch 105 is completely covered by the second plate 2. Such a design provides more space for a user to push against the second plate 2; it also makes it more difficult for a user to locate the specific position of the notch.

As shown in FIG. 1, panel (A), the overall size of the first plate 10 is larger than that of second plate 2, so that the second plate 20 rests against the first plate inner surface 11 in the closed configuration without extending beyond the second plate 20 except at the position of notch 105. In particular, except for the notched edge 13, one or all the other edges of first plate 10 extend beyond the corresponding edges of the second plate 20 in a closed configuration. Such a design provide additional advantage compared to the designs in which the edges of the first plate 10 and second plate 20 all align. Such a design allows a user to easily stabilize the device when a force to open the plates is applied. For example, in some embodiments, the user stabilizes the device by taking hold of the first plate 10 on the side edges (as compared to the hinge edge and the notched edge) and push against the second plate 20 to open the device.

As shown in FIG. 1, panel (B), in some embodiments, one of the plates, e.g. the second plate 20, is recessed on the edges to the corresponding edge of the other plate, e.g. the first plate 10. In certain embodiments, there are one, two, three, or four recessed edges of one plate compared to the adjacent parallel edges on the other plate.

The width of the recess (e.g. recess 154 or recess 152) can vary. In some embodiments, the width of the recess is less than 1/100, 1/50, 1/24, 1/12, 1/10, 1/9, ⅛, ⅙, ⅕, ¼, ⅓, ½, or ⅔ of the width of the recessed plate, or in a range between any of the two values. In some embodiments, the width of the recess is less than 1 um, 10 um, 20 um, 30 um, 40 um, 50 um, 100 um, 200 um, 300 um, 400 um, 500 um, 7500 um, 1 mm, 5 mm, 10 mm, 100 mm, or 1000 mm, or in a range between any of the two values.

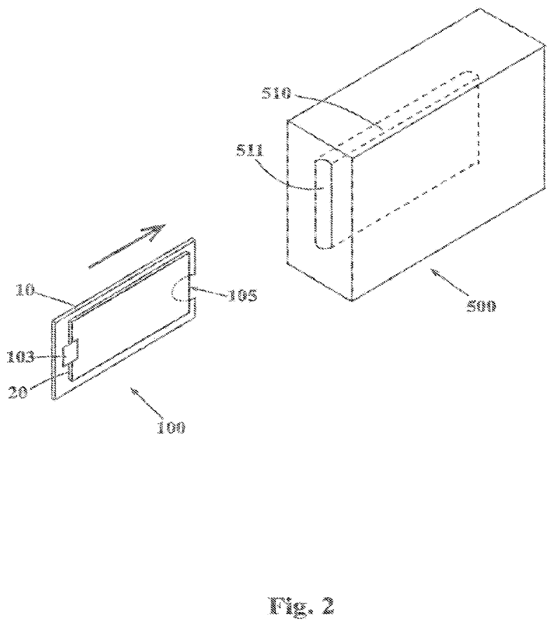

FIG. 1 also shows a cross-sectional view of the QMAX card in the closed configuration (panel (B)) and open configuration (panel (C)). As shown in panels (B) and (C) of FIG. 1, in some embodiments, the QMAX comprises a first plate 1, a second plate 2, and a hinge 103, wherein the hinge 103 comprises a first leaf 31, a second leaf 32, and a hinge joint 36, which allows the two plates to pivot against each other and switch between a closed configuration and an open configuration. In the embodiment shown in FIG. 1, the first leaf 31 of the hinge 103 is positioned entirely against the first plate inner surface 11 without contacting any edge of the first plate 1. Such a design facilitates the manufacturing process of the device by making the hinge 103 easier to attach. However, it should be noted that the presence of the opening mechanism, such as but not limited to notch 105, not related to the specific design of the hinge in all embodiments. It would be possible to utilize the opening mechanism in the embodiments shown in FIG. 2.

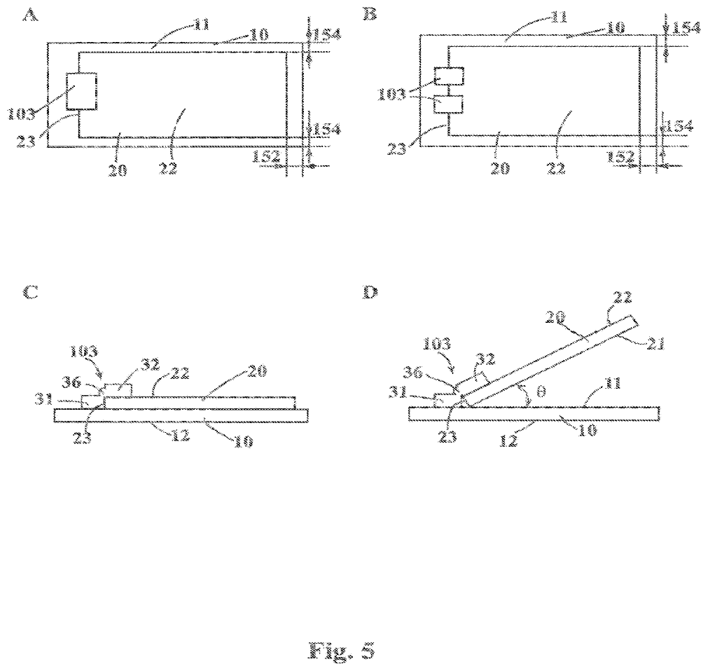

As shown in FIG. 1, panel (B), the cross-section here shows the view marked by indicators “a” and “a′” in FIG. 1, panel (A) where the dotted line indicates the positioning of the section over the notch 105. Panel (A) shows that at the aa′ position, due to the presence of the notch 105, the opening edge 24 of the second plate 20 is farther from the second plate hinge edge 23 than the notched edge 13 of the first plate 1. Such a design allows a user to apply an external force, as shown in FIG. 5, panel (A), to the opening edge 24 and/or the second plate inner surface (not marked) right above the notch 105, to open the device. In essence, the presence of notch 105 facilitate a user's action to apply a force to change the plates from a closed configuration to an open configuration. In some embodiments, the force is applied by a human finger.

FIG. 1 panel (C) shows an embodiment of the QMAX card in an open configuration. In essence, the first plate 10 and the second plate 20 forms an angle θ. When θ is substantially 0 degree, the device is in the closed configuration; when θ is not substantially 0 degree, the device is in the open configuration. The angle θ is limited by the positioning of the hinge 103 and/or other mechanisms. In some embodiments, θ is less than 5, 10, 15, 30, 45, 60, 75, 90, 105, 120, 135, 150, 165 or 180, or in a range between any of the two values. For example, in an embodiment as shown in FIG. 1 panel (C), θ is in the range of 0 to 180 degrees. In another embodiment, θ is in the range of 0 to 360 degrees.

As shown in FIG. 1, the presence of the notch 105 makes it easier for a user to change the plates from a closed configuration to an open configuration. In addition, notch 105 also generally makes it easier for a user to manipulate the angle between the second plate 20 and the first plate 10 by pushing and/or pulling the opening edge 24 of the second plate 20 or any areas close to the opening edge 24. For example, the user pushes the opening edge 24 to change the θ for less than 1 degree, 2, 3, 4, 5, 6, 7, 8, 9,10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180, or in a range between any of the two values.

### 5. QMAX Card and Adapter

FIG. 2 shows the perspective view of an exemplary embodiment of the QMAX card 100 and an adapter 500. As shown in FIG. 2, in some embodiments, the QMAX card 100, when in a closed configuration, can be inserted into a slot 510 of the adapter 500. In some embodiments, the adapter 500 can be attached to a mobile communication device so that the mobile communication device can read the QMAX card 100 by taking images of the sample in the card and/or conducting measurement and analysis of certain analytes in the sample.

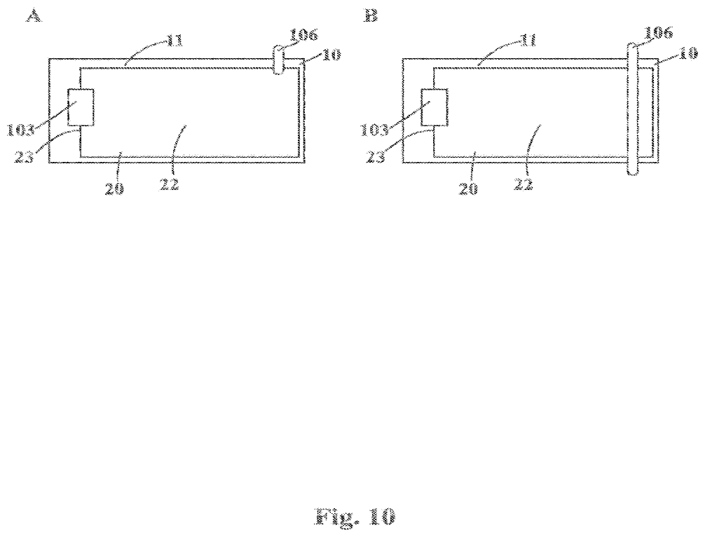

As shown in FIG. 10, in some embodiments, the edges of the second plate 20 of the QMAX card is recessed inside the first plate 10. For example, in the closed configuration, each edge of the second plate 20 is positioned behind (i.e. recessed from) the corresponding parallel edge of the first plate 10 and abuts the inner surface of the first plate 10. In certain other embodiments, only the edges of the second plate 20 that are parallel to the direction of insertion into the slot 510 are recessed inside the first plate 10. The slot 510 is configured to accommodate the body of the QMAX card 100. With the recesses on the edges of the second plate 20, the size of the first plate 10 represents the size of the QMAX card 100. In some embodiments, recessing the second plate edges prevents the opening 511 of the slot from bumping into the second plate to open to plates. In some embodiments, the second plate 20 with recesses allows the QMAX card to be inserted into the slot 510 more easily and prevents the QMAX card 100 from accidental opening before and during insertion. In some embodiments, the sizing and recess positioning of the first plate and the second plate can be reversed—such a design can also provide easy insertion and reduce accidental opening.

### 6. Examples of QMAX Card with Hinges and Notches and Recessed Edges

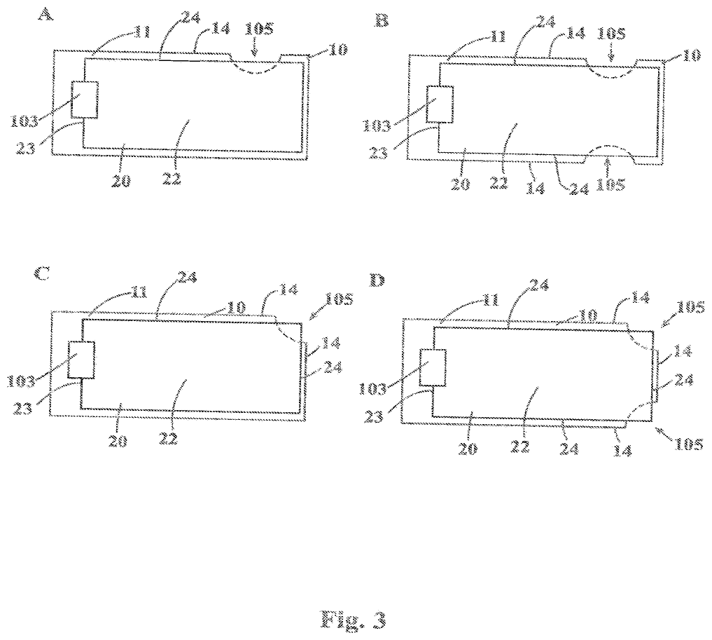

FIG. 3 shows the top view of four other exemplary embodiments of the QMAX card comprising a first plate 1, a second plate 20 and a hinge 103, wherein the first plate 10 comprise one or more notches 105 on its one or more notched edges. The presence of the notch(es) 105 facilitates a user's actions to manipulate the angle between the first plate 10 and the second plate 2.

In FIG. 1, the notch 105 is positioned on an edge opposite to the hinge edge 23 of the second plate 20. As shown in FIG. 3, however, it is possible to position the notch 105 on other edge(s). Notch 105 is positioned on any edge as long as it effectively serves its key functions—facilitating a user's actions to manipulate the angle between the first plate 10 and the second plate 2.

The number of notch(es) 105 also varies according to the specific needs of the user and the device. For example, while the embodiments shown in FIG. 1 and FIG. 3 panels (A) and (C) include one notch 105, the embodiment in FIG. 3 panels (B) and (D) include two notches 105. It is also possible to include more notches 105. In some embodiments, the presence of two (or more) notches 105 provides more options to a user or allow the user to use, for example, two fingers to open the plates.

In FIG. 1, the notch 105 is positioned on a single edge of the first plate 1. As shown in FIG. 3, panels (C) and (D), however, it is possible to position the notch 105 at the intersection of two neighboring notched edges 13. For example, there are two neighboring notched edges 13 in panel (C) co-harboring one notch 105 at their intersection, while there are three notched edges 13 in panel (D), wherein any two neighboring edges co-harbor one notch 105 at their respective intersection, totaling two notches in this device. In other embodiments, there are more than two notches that are positioned at the intersections of neighboring notched edges. In yet other embodiments, the QMAX card comprises a number of notches positioned at the intersections of neighboring notched edges together with a number of other notches, each of which is positioned at a single notched edge. Correspondingly, the second plate 20 in FIG. 3, panel (C) comprises two opening edges 24 juxtaposed partially over the notch 105, while the second plate 20 in panel (D) comprises three opening edges 24. In some embodiments, the second plate 20 has different lateral shape from the first plate 10, or the number of the corresponding opening edges in second plate 20 is different from the number of notched edges in first plate 1, as long as the notches 105 facilitate a user's action to manipulate the angle between the first plate 10 and the second plate 2.

### 7. Examples of QMAX Device with Hinges (QMAX Card)

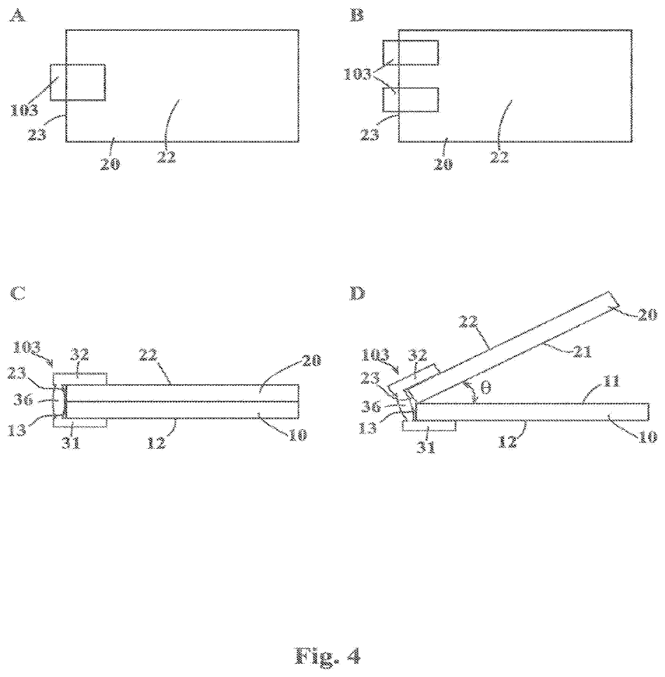

FIG. 4 shows two exemplary embodiments of the QMAX card with hinges (i.e. QMAX card). Panel (A) of FIG. 4 shows the top view of a QMAX card that comprises a first plate 10 (not shown), a second plate 2, and a hinge 103 that connects the first plate 10 with the second plate 20 in a closed configuration. In Panel (B), the QMAX card comprises a first plate 1, a second plate 20 (not shown), and two hinges 103 in a closed configuration. Panel (C) of FIG. 4 shows a sectional view of the QMAX card in a closed configuration, wherein the QMAX card comprises a first plate 1, a second plate 2, and a hinge 103. Panel (D) of FIG. 4 shows a sectional view of the QMAX card in an open configuration, wherein the QMAX card comprises a first plate 1, a second plate 2, and a hinge 103.

Referring to panels (A) and (B) of FIG. 4, from a top view the second plate 20 covers the first plate 10 (not shown). It should be noted, however, that in some embodiments the second plate 20 is larger or smaller than the first plate 1. Referring to panels (C) and (D) of FIG. 4, the first plate 10 comprises an inner surface 11 and an outer surface 12; the second plate 20 comprises an inner surface 21 and an outer surface 22, wherein the first plate inner surface 11 faces the second plate inner surface in the closed configuration. As shown in panel (D) of FIG. 4, the second plate 20 and the first plate 10 are at least partially separated apart.

As indicated in FIG. 1, the first plate 10 and/or the second plate 20 comprise spacers that are fixed on either or both of the plates. In some embodiments, the spacers are also un-fixed and mixed with the sample. Referring to FIG. 4, in some embodiments, the spacers (not shown) are fixed on either or both of the inner surfaces 11 and 12. In the open configuration, the spacing between the plates are not regulated by the spacers. In the closed configuration, the spacing between the plates are regulated by the spacers. In some embodiments, the device of the present invention does not include spacers and the thickness of the sample in the closed configuration is regulated by other mechanisms.

As shown in FIG. 4, panels (C) and (D), the first plate 10 comprises a first plate hinge edge 13 and the second plate 20 comprises a second plate hinge edge 23; the hinge edges are aligned to each other and the hinge 103 wraps around the hinge edges, connecting the first plate 10 and the second plate 2. The hinge 103 comprises a first leaf 31, a second leaf 32 and a hinge joint 36. The hinge joint 36 allows the first leaf 31 and the second leaf 32 to rotate around the hinge joint 36. As shown in panels (C) and (D), the first leaf 31 is attached to the first plate outer surface 12, the second leaf 32 is attach to the second plate outer surface 22, allowing the first plate 10 and the second plate 20 to rotate around the hinge joint 36. Thus, in some embodiments, the two plates pivot against each other and switch between an open configuration and a closed configuration.

FIG. 5 shows two exemplary embodiments of the QMAX card with hinges. Panel (A) of FIG. 5 shows the top view of a QMAX card that comprises a first plate 10, a second plate 20, and a hinge 103 that connects the first plate 10 with the second plate 20 in a closed configuration. As show in panel (A), the first plate 10 comprises an inner surface 11 and an outer surface (not shown); the second plate 20 comprises an inner surface (not shown) and an outer surface 22, wherein the first plate inner surface 11 faces the second plate inner surface in the closed configuration. Panel (B) of FIG. 5 shows an embodiment of the QMAX card comprising essentially the same elements as panel (A), except that there are two hinges 103 that connect the first plate 10 and the second plate 2.

Panel (C) of FIG. 5 shows a sectional view of the QMAX card in a closed configuration, wherein the QMAX card comprises a first plate 10 and a second plate 20 and a hinge 103 that connects the plates. In the closed configuration, the first plate inner surface 11 and second plate inner surface 21 face each other and the spacing between the first plate 10 and the second plate 20 is regulated by spacers fixed on either the first plate inner surface 11 or second plate inner surface 12. Panel (D) of FIG. 5 shows a sectional view of the QMAX card in an open configuration, wherein the QMAX card comprise a first plate 10, a second plate 20, and a hinge 103 connecting the plates. In the open configuration, the inner surfaces of the first plate 10 and the second plate 20 are separated apart and the spacing between the first plate and the second plate are not regulated by spacers.

Referring to FIG. 4 and FIG. 5, the size of the hinge 103 vary and can be adjusted according to the size of the plates and the specific needs of the application for the device. For example, the length of the hinge joint 36 are less than 1 mm, 2 mm, 3 mm, 4 mm, 5 mm, 10 mm, 15 mm, 20 mm, 25 mm, 30 mm, 40 mm, 50 mm, 100 mm, 200 mm, or 500 mm, or in a range between any of the two values. In some embodiments, the ratio of the length of the hinge joint 36 to the length of the plate edge with which the hinge joint 36 is aligned is less than 1.5, 1, 0.9, 0.8, 0.7, 0.6, 0.5, 0.4, 0.3, 0.2, 0.1, 0.05 or in a range between any two of these values. In one embodiment, the ratio of the length of the hinge joint 36 to the length of the plate edge with which the hinge joint 36 is aligned is 1, indicating that the hinge joint 36 completely covers the hinge edge. In some embodiments, the overall area of the hinge is less than 1 mm², 5 mm², 10 mm², 20 mm², 30 mm², 40 mm², 50 mm², 100 mm², 200 mm², 500 mm², or in a range between any of the two values. In certain embodiments, the ratio of the overall size of the hinge 103 to the overall size of one of the plates is less than 1, 0.9, 0.8, 0.7, 0.6, 0.5, 0.4, 0.3, 0.2, 0.1, 0.05, 0.01 or in a range between any two of these values.

As shown in FIG. 5, in some embodiments, the hinge 103 is positioned so that first leaf 31 is attached to the first plate inner surface 11, the second leaf 32 is attached to the second plate outer surface 22, and the hinge joint 36 is positioned longitudinally parallel to the hinge edge 23, allowing the two plates to pivot against each other and switch between an open configuration and a closed configuration. As shown in FIG. 5, in some embodiments, the hinge 103 is aligned with, but do not wrap around any of the plate edges.

As show in FIG. 5, panel (D), and also referring to panel (D) of FIG. 4, the first plate 10 rotates around the hinge joint 36 in the open configuration, in which the first plate 10 and second plate 20 are separated apart and the spacing between the plates are not regulated by the spacers 4. In addition, an angle θ is formed between the first plate 10 and the second plate 2; when the angle θ is substantially 0 degree, the device is in a closed configuration; when θ is not substantially 0 degree, the device is in an open configuration. The term “substantially 0 degree” means less than 0.01 degree, 0.1 degree, 0.5 degree, 1 degree, 2 degrees, 3 degrees, 4 degrees or 5 degrees, or in a range between any of the two values. The hinge 103 allows the first plate 10 and the second plate 20 to rotate around the hinge joint 36 and change the angle between the first plate 10 and second plate 2. For an adjustment of the angle θ, it is termed that the plates are adjusted from a starting angle to a target angle, or from a first angle to a second angle.

As shown in FIG. 5, in some embodiments, the first leaf 31 is positioned entirely on the first plate inner surface 11 without contacting any edge of the first plate 1. In other words, when attached, the first leaf 31 is entirely within the area of the first plate inner surface 11. With such a design, in the closed configuration the first leaf 31 and the second leaf 32 are parallel to each other and the hinge joint 36 is longitudinally aligned with the hinge edge 23 of the second plate 2. Such positioning of the hinge 103 facilitates the manufacturing of the QMAX card, especially the step to attach the hinge. For example, since the entire body of the hinge 103 is aligned in parallel with the first plate 10 and second plate 20 in the closed configuration, the hinge 103 is attached to the first plate 10 and the second plate 20 with a single molding or gluing process.

In some embodiments, the design shown in FIG. 5 also limits the rotation of the plates relative to each other but facilitates depositing a sample on the first plate 10 or second plate 2. For example, in some embodiments with the hinge design shown in FIG. 5, the angle θ between the first plate 10 and the second plate 20 is limited to equal to or less than 180 degrees. A user of the device simply opens the first plate 10 and the second plate 20 to 180 degrees and deposit the sample (e.g. a drop of body fluid such as but not limited to blood) onto any one of the plates. Referring to panel (D) of FIG. 4, two edges of the first plate 10 and second plate 20 are aligned with each other and the hinge wraps around these edges. Such a design allows the first plate 10 and second plate 20 to rotate around the hinge joint 36 into a wide angle. In some embodiments, the angle θ which is changed for less than 15, 30, 45, 60, 75, 90, 105, 120, 135, 150, 0 to 165, 180, 195, 210, 225, 240, 255, 270, 285, 300, 315, 330, 345 or 360 degrees, or in a range between any of the two values. It should also be noted that other mechanisms also are employed to limit the range of the angle.

Referring to panel (B) of FIG. 4 and Panel (B) of FIG. 5, which show that the first plate 10 and second plate 20 are connected by two hinges 103. The specific number of hinges is decided by the specific requirement of the assay and the manufacturing parameters. It is also possible that different types of hinges are used alongside one another to connect the first plate 10 and second plate 20.

### 8. Multiple Plates with Multiple Hinges

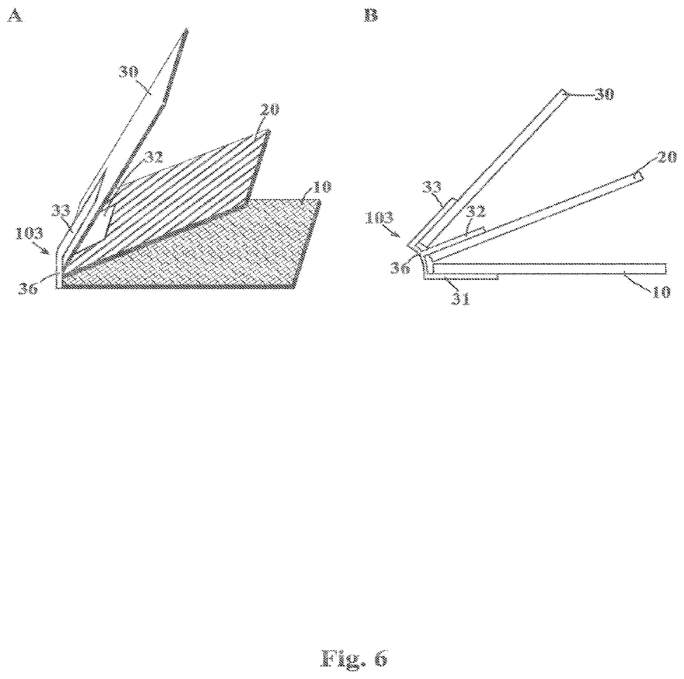

FIG. 6 shows perspective and sectional views of a multi-plate embodiment of a QMAX card. Panel (A) illustrates a perspective view of the QMAX card that comprises a first plate 10, a second plate 20 and a third plate 30; the plates are connected by a hinge 103 that comprises a first leaf 31 (not shown in panel (A)), a second left 32, and a third leaf 33; panel (B) illustrates a sectional view of the QMAX card, demonstrating the connection between the hinge 103 and the first plate 10, the second plate 20, and the third plate 30; in particular, the first leaf 31 is connected to the first plate 10, the second leaf 32 is connected to the second plate 20, and the third leaf 33 is connected to third plate 30, allowing all the plates to pivot against each other into different configurations. Spacers are present in any one, two, or all of the plates.

### 9. QMAX Card with Spacers

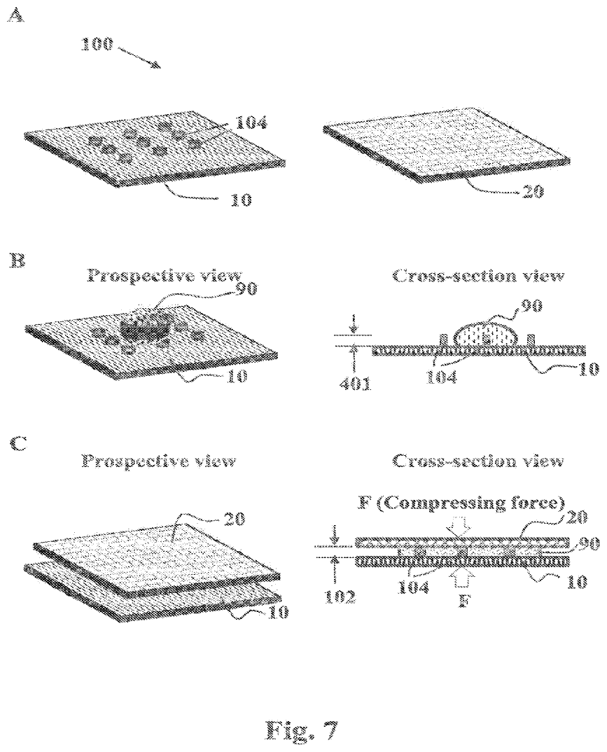

FIG. 7 shows an embodiment of a generic QMAX card that have spacers, with or without a hinge, and wherein Q: quantification; M: magnifying; A: adding reagents; X: acceleration; also known as compressed regulated open flow (CROF)) device. The QMAX card comprises a first plate 10 and a second plate 2. In particular, panel (A) shows the perspective view of a first plate 10 and a second plate 20 wherein the first plate has spacers. It should be noted, however, that the spacers also are fixed on the second plate 20 (not shown) or on both first plate 10 and second plate 20 (not shown). Panel (B) shows the perspective view and a sectional view of depositing a sample 100 on the first plate 10 at an open configuration. It should be noted, however, that the sample 100 also is deposited on the second plate 20 (not shown), or on both the first plate 10 and the second plate 20 (not shown). Panel (C) illustrates (i) using the first plate 10 and second plate 20 to spread the sample 100 (the sample flow between the inner surfaces of the plates) and reduce the sample thickness, and (ii) using the spacers and the plate to regulate the sample thickness at the closed configuration of the QMAX card. The inner surfaces of each plate have one or a plurality of binding sites and or storage sites (not shown).

In some embodiments, the spacers 40 have a predetermined uniform height and a predetermined uniform inter-spacer distance. In the closed configuration, as shown in panel (C) of FIG. 7, the spacing between the plates and the thus the thickness of the sample 100 is regulated by the spacers 4. In some embodiments, the uniform thickness of the sample 100 is substantially similar to the uniform height of the spacers 4. It should be noted that although FIG. 7 shows the spacers 40 to be fixed on one of the plates, in some embodiments the spacers are not fixed. For example, in certain embodiments the spacers is mixed with the sample so that when the sample is compressed into a thin layer, the spacers, which is rigid beads or particles that have a uniform size, regulate the thickness of the sample layer.

FIG. 7 shows an exemplary embodiment of the QMAX card in which the first plate 10 and the second plate 20 are not shown to be connected or not. In some embodiments, the plates are not connected. However, in some other embodiments, the first plate 10 and second plate 20 are connected, e.g. by connectors such as but not limited to hinges, straps and fasteners. Such connectors link the first plate 10 and the second plate 20 and allows the QMAX card to switch between the open configuration and the closed configuration.

FIG. 8 shows an embodiment of a QMAX card that has spacers, multiple plates, and multiple hinges. The QMAX card comprises a first plate 10, a second plate 20, a third plate 30 and spacer 40. Panel (A) shows the perspective view of the plates in an open configuration, in which: the plates are partially or entirely separated apart, the spacing between the plates are not regulated by the spacers 40, allowing a sample to be deposited on the one or more of the plates or one a structure, e.g. filter, this is placed on top of one of the plates; panel (B) shows the sectional view of the plates at the open configuration.

As shown in panels (A) and (B) of FIG. 8, in some embodiments the second plate 20 and the third plate 30 are both connected to the first plate 10. In certain embodiments, the second plate 20 is connected to the first plate 10 with a hinge 103; the third plate 30 is connected to the first plate 10 with another hinge 103. The second plate 20 and the third plate 30 are configured such that each can pivot toward and away from the first plate 10 without interfering with each other. In some embodiments, the surface of the first plate 10 facing the second plate 20 and the third plate 30 is defined as the inner surface; the surfaces of the second plate 20 and the third plate 30 that face the first plate 10 are also defined as the inner surfaces of the respective plates. In some embodiments, the hinges 103 are partly placed on top of the inner surface of the first plate 10 and connect the second plate 20 and the third plate 30 to the first plate 10. In certain embodiments, the edges of the second plate 20 and/or the edges of the third plate 30 are not closely aligned with the edge of the first plate 10. In certain embodiments, the hinges 103 do not wrap around any edge of the first plate 10. It should also be noted, however, that the second plate 20 and the third plate 30 are not required to be connected to the first plate 10. In certain embodiments, the second plate 20 and/or the third plate 30 are completely separated from the first plate 10.

Panels (A) and (B) of FIG. 8 also show spacers 40, which are fixed on the first plate 10. It should also be noted, however, that the spacers 40 can be fixed on the third plate 30, the second plate 20 or any selections and combinations of the three plates. In certain embodiments, the spacers 40 are fixed on the inner surfaces of the first plate 10 and the third plate 30. In certain embodiments, the spacers 40 are fixed on the inner surfaces of the first plate 10 and the second plate 20. In certain embodiments, the spacers 40 are fixed on the inner surfaces of the second plate 20 and the third plate 30. In certain embodiments, the spacers 40 are fixed only on the first plate 10. In certain embodiments, the spacers 40 are fixed only on the second plate 20. In certain embodiments, the spacers 40 are fixed only on the third plate 30. In certain embodiments, the spacers 40 are fixed on all three plates. When the spacers 40 are fixed on more than one plate, the spacer heights on the different plates can be the same or different. In some embodiments, the spacers 40 are not fixed on any plate but are mixed in the sample.

### 10. Structure and Material of the Hinge

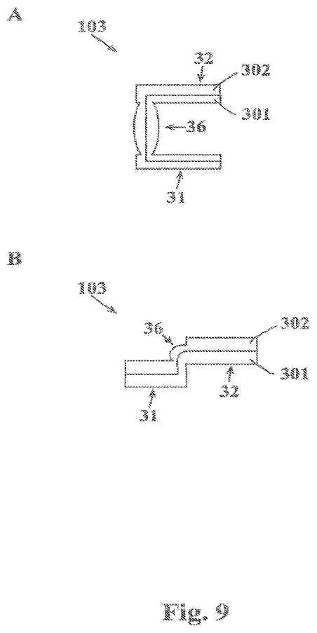

FIG. 9 shows a cross-sectional view of two exemplary embodiments of a hinge 103. Panel (A) of FIG. 9 shows a hinge 103 that has the design as shown in FIG. 9. Panel (B) of FIG. 9 shows a hinge 103 that has the design as shown in FIG. 5. As shown in FIG. 9, panels (A) and (B), in a lateral direction, the hinge 103 comprises a first leaf 31, a hinge joint 36, and a second leaf 32. Here, the term “lateral” means dividing the flat body of the hinge 103 vertically into different segments having different mechanical, physical or chemical properties and/or serving different functions. Also as shown in FIG. 9, panels (A) and (B), in a horizontal direction, the hinge 103 comprises more than one layers. Here, the term “horizontal” means dividing all or part of the flat body of the hinge 103 horizontally into different layers having different mechanical, physical or chemical properties and/or serving different functions. For example, panels (A) and B shows that, in some embodiments, the hinge 103 comprises a first layer 301 and a second layer 302. It is also possible that the hinge 103 comprises a uniform single layer. In other embodiments, the hinge 103 also comprises more than two layers.

The different layers of the hinge 103 has the same or different thickness. In some embodiments, any layer of the hinge 103 have a thickness in 0.1 um, 1 um, 2 um, 3 um, 5 um, 10 um, 20 um, 30 um, 50 um, 100 um, 200 um, 300 um, 500 um, 1 mm, 2 mm, and a range between any two of these values

In one embodiment, any of the layers of hinge 103 has a thickness in the range of 25 μm to 50 μm.

In some embodiments, as shown in FIG. 9, the different layers span across the entire flat body of the hinge 103. It should be noted, however, that the different layers also only span across part of the hinge 103. In some embodiments, for example, the first layer 301 only span across the first leaf 31, the hinge joint 36 or the second leaf 32. In some embodiments, the second layer 302 only spans across the first leaf 31, the hinge joint 36 or the second leaf 32. Each of the leaves comprises one layer, two layers, three layers or more layers and the first leaf 31 and the second leaf 32 each comprises different number of layers. The hinge joint 36 also comprises one layer, two layers, three layers or more layers, and the layer number in the joint 36 is the same as or different from the number of layers the leaves comprise.

In some embodiments, the hinge 103 comprises a single layer, which is made from a metallic material that is selected from a group consisting of gold, silver, copper, aluminum, iron, tin, platinum, nickel, cobalt, alloys, or any combination of thereof.

In one embodiment, the metallic material of the hinge 103 is aluminum. In some embodiments, the hinge 103 comprises a single layer, which is made from a polymer material, such as but not limited to plastics. Referring to panels (A) and (B) of FIG. 4, when the hinge 103 comprises more than one layer, different layers is made from different materials. For example, in some embodiments, the first layer 301 is made from a polymer material, such as but not limited to plastics and the second layer 302 is made from a metallic material. In addition, it would also be possible that the first layer 301 is made from a metallic material and the second layer 302 is made from a polymer material.

The polymer material for the hinge is selected from the group consisting of acrylate polymers, vinyl polymers, olefin polymers, cellulosic polymers, noncellulosic polymers, polyester polymers, Nylon, cyclic olefin copolymer (COC), poly(methyl methacrylate) (PMMB), polycarbonate (PC), cyclic olefin polymer (COP), liquid crystalline polymer (LCP), polyimide (PB), polyethylene (PE), polyimide (PI), polypropylene (PP), poly(phenylene ether) (PPE), polystyrene (PS), polyoxymethylene (POM), polyether ether ketone (PEEK), polyether sulfone (PES), poly(ethylene phthalate) (PET), polytetrafluoroethylene (PTFE), polyvinyl chloride (PVC), polyvinylidene fluoride (PVDF), polybutylene terephthalate (PBT), fluorinated ethylene propylene (FEP), perfluoroalkoxyalkane (PFB), polydimethylsiloxane (PDMS), rubbers, or any combinations of thereof. In some embodiments, the polymer material is selected from polystyrene, PMMB, PC, COC, COP, or another plastic. The metallic material for the hinge is selected from a group consisting of: gold, silver, copper, aluminum, iron, tin, platinum, nickel, cobalt, or alloys. In some embodiments, the metallic material is aluminum.

The hinge 103 is attached to the plates with any means that is applicable. For example, the hinge 103 is attached to plate by molding. In some embodiments, the hinge 103 is attached to the plate by glue. The term “glue” as used herein, means any adhesive substance used for sticking objects or materials together. In some embodiments, the adhesive material the glue is made from include, but not limited to: starch, dextrin, gelatin, asphalt, bitumen, polyisoprene, natural rubber, resin, shellac, cellulose and its derivatives, vinyl derivatives, acrylic derivatives, reactive acrylic bases, polychloroprene, styrene-butadiene, styrene-diene-styrene, polyisobutylene, acrylonitrile-butadiene, polyurethane, polysulfide, silicone, aldehyde condensation resins, epoxide resins, amine base resins, polyester resins, polyolefin polymers, soluble silicates, phosphate cements, or any other adhesive material, or any combination thereof. In some embodiments, the glue is drying adhesive, pressure-sensitive adhesive, contact adhesive, hot adhesive, or one-part or multi-part reactive adhesive, or any combination thereof. In some embodiments, the glue is natural adhesive or synthetic adhesive, or from any other origin, or any combination thereof. In some embodiments, the glue is spontaneous-cured, heat-cured, UV-cured, or cured by any other treatment, or any combination thereof.

### 11. Examples of Hinge Mounting Positions

In some embodiments, the hinge is mounted on one side of the QMAX card, facilitating the process to produce the QMAX card. For example, as shown in FIG. 5, one edge of the first plate is off-set from one edge of the second plate, so that a hinge is configured to be positioned over one of the edge of a plate, such that a first leaf of the hinge is attached to the outer surface of the plate, while a second leaf is attached to the inner surface of the other plate, and the hinge joint is positioned along and near the edge of the plate that the hinge covers. When the hinge is mounted to one side of the QMAX card, the production of the QMAX, especially the attachment of the hinge, is, in many cases, simplified and made more efficient.

In some embodiments, since the entire body of the hinge 103 is aligned in parallel with the first plate 10 and second plate 20 in the closed configuration, the hinge 103 is attached to the first plate 10 and the second plate 20 with a single molding or gluing process. The manufacturing process is facilitated.

In some embodiments, the hinge is mounted on both side of the QMAX card. For example, in the embodiments shown in FIG. 4, the first leaf is attached to the outer surface of the first plate and the second leaf is attached to the outer surface the second plate, wherein one edge of the first plate is aligned to one edge of the second plate, and these edges of the plates are aligned with the joint of the hinge, allowing the first plate and the second plate to pivot against each other to form different configurations. With such positioning of the hinge, the angle between the second plate and the first plate has, in some embodiments, a wide range between 0 and 360 degrees.

### 12. QMAX Card with Tab

FIG. 10 show the top views of two exemplary embodiments of the QMAX card, which comprises a first plate 10, a second plate 20 and a hinge 103 connecting the first plate 10 and the second plate 20. As shown in FIG. 10, the second plate 20 also comprises one (panels (A) and (B)) or more (not shown) tabs 6 attached to a second plate outer surface 22. In some embodiments, a user of the device pulls the handle portion of the tab 106 to switch the two plates from the closed configuration to the open configuration. The user also uses the tab 106 to manipulate the angle between the first plate 10 and the second plate 20 by taking hold of the handle portion of the tab 106. In fact, the descriptions above related to the notches 105 shown in FIGS. 6-7 and the manipulation of the angle 6 also applies to the tab 106 shown in FIG. 10.

As shown in FIG. 10, the tab 106 is attached to the second plate outer surface 22 and protrude out of the edge of the second plate 20 to form a handle portion so that it is easier for a user to take hold of the tab 106. It is also possible that in some embodiments, the tab 106 is attached directly to an edge of the second plate 2, as long as the edge is not the hinge edge.

As shown in panels (A) and (B) of FIG. 7, the size of the tab 106 varies according to specific designs. For example, in the embodiment shown in panel (A), the tab 106 does not span the entire width of the second plate 20 and protrudes only out of one edge of the second plate 2. In the embodiment shown in panel (B), the tab 106 spans the entire width of the second plate 20 and protrudes out of two edges of the second plate 2. The design in panel (B) provides more options to a user but is unnecessary if the presence of a short tab (e.g. as shown in panel (A)) would be sufficient for its function.

Referring to FIG. 1-8, it is possible to position opening mechanisms (notch 105 and tab 106) on a different plate from what is shown in the Figures. For example, while FIG. 1 shows that the notch 105 is included in the first plate 10, it would also be possible to position it in the second plate 20 and be covered, partially or entirely, but the first plate 10. Similarly, it is possible that the tab 106 is present on the first plate 10, instead of the second plate 20. It should be noted, however, that the change of the positioning of the opening mechanism requires a change of the overall size and/or design of the other features of the first plate 10 and second plate 20.

### 13. Examples of Angle Self-Maintaining Hinge

In some embodiments, the hinge in the device of the present invention self-maintains the angle between the two plates after the angle has been adjusted. The term “self-maintain” means without additional assist or additional device beyond the hinge itself.

As shown in FIGS. 1, 4 and 5, the angle θ of the hinge is adjusted from one position to another position, (for example, by applying an external force to move the plates and hinge). In general, due to the gravitational force (e.g. the weight of the plates) and/or the internal forces of the hinge, the angle 6 of the hinge can, after the external force is removed, change significantly from the angle when the external force is there. A “angle self-maintaining hinge” means that after an external force that moves the plates/hinge from an initial angle into a final angle and the external force is removed from the plates/hinge, the hinge substantially maintains the final angle (hence the plates' final angle). Here, “substantially maintains the an angle” mean that the angle difference, which the difference between the final angle before the removal of the external force and the angle after the removal the external force (e.g. the angle difference with and without the external force), is less than 1, 2, 3, 4, 5, 6, 7, 8, 9, 10, 15, 20, 25, 30, 35, 40, or 45 degrees, or in a range between any of the two values.

An angle self-maintain hinge self maintains an angle with the angle difference 5 degrees or less in some embodiments, within 10 degrees in some other embodiments, or within 30 degrees in certain embodiments.

In some embodiments, the hinge comprises a layer of material that self-maintains the shape of the hinge after bending, wherein the material layer is made from a single material, a mixture or compound of materials, or multiple layers of single material and/or mixture or compound materials. In some embodiments, the material that has angle self-maintaining property is a metallic thin film (e.g. aluminum film).

In some embodiments, a single layer of metal (e.g. aluminum) would be sufficient to provide angle self-maintaining properties. However, in certain embodiments the metal layer is susceptible to a tearing force that breaks the hinge. To prevent tearing of the hinge and other advantages, in some embodiments, an angle self-maintaining hinge comprises a plastic layer together with the metal (e.g. aluminum) material. In certain embodiments, a hinge is constructed by laminating the plastic layer with the aluminum. In some embodiments, the plastic layer is a thin layer of a glue.

In some embodiments, a glue covers not only the portion of the hinge 103 that connects to the plates, but also the portion of the hinge that rotes, hence the glue modifies the rotation properties of the hinge. For example, a hinge 103 comprises a single thin film (25 micron thick, and the thickness is significantly uniform before) of aluminum and with a 3 micron thick of glue that covers entire surface of the aluminum hinge that connect to the plates, including the hinge rotation part. The layer of glue will strengthen the rotation part of the hinge, while maintaining the “rotation angle maintain property of the aluminum.”

In some embodiments, the glue forms a layer and is considered part of the hinge 103. In certain embodiments, the hinge 103 comprises a first layer 301 which is made of metallic material, a second layer 302 which is a layer of plastics, and a third layer which is a layer of glue.

Different layers serve different functions. For example, a layer of glue attaches the hinge 103 to the first plate 1, the second plate 2, or both of the plates. A layer of polymer material, such as but not limited to polystyrene, PMMA, PC, COC, COP, provides mechanism support to the hinge 103. It would also be possible that the first layer 301 is a layer of plastic material which is molded to the first plate 10 and second plate 20.

A layer of metal provides mechanical support and/or maintains the angle formed by the first plate and the second plate after the angle is changed by an external force. For example, a user applies an external force to changes the QMAX card from one configuration to another, e.g. from the closed configuration to the open configuration, the layer of metal prevents the device from reverting to the configuration, e.g. the closed configuration, after the external force is removed. Such a design also applies to different angles between the first plate 10 and the second plate 2. For example, a user applies an external force to change the angle between the first plate 10 and the second plate 20 from a first θ to a second θ, one or more layers, such as but not limited to a layer of metal, in hinge 103 prevents a significant adjustment to the second after the external force is removed. In some embodiments, the metal layer substantially maintains the second θ by preventing an adjustment of more than ±90, ±45, ±30, ±25, ±20, ±15, ±10, ±8, ±6, ±5, ±4, ±3, ±2, or ±1, or in a range between any of the two values, for the second after the external force is removed.

In some embodiments, after deposition of the sample and after the QMAX card is switched to a closed configuration, the card is inserted into a card slot for imaging and/or analysis; then the card is extracted from the card slot. One aspect of the present invention is that the hinge is configured to maintain the closed configuration of the QMAX card after the external force to change the QMAX card to the closed configuration has been removed. In such a manner, the QMAX card can slide into and slide out of the card slot without accidental separation of the two (or more—see FIG. 6) plates.

### 14. Methods of Making a QMAX Card with a Hinge (QMAX-Card)

In some embodiments in fabricating the QMAX card, the first plate, the second plate, and the hinge is fabricated separately first, then the first plate and the second plate are placed together, and finally the hinge is connected to the first plate and the second plate.

In some embodiments in fabricating QMAX card, the hinge and one of the plates is put together, and then the other plate is put on the hinge.

### 15. QMAX Card with Overflow Prevention Mechanism

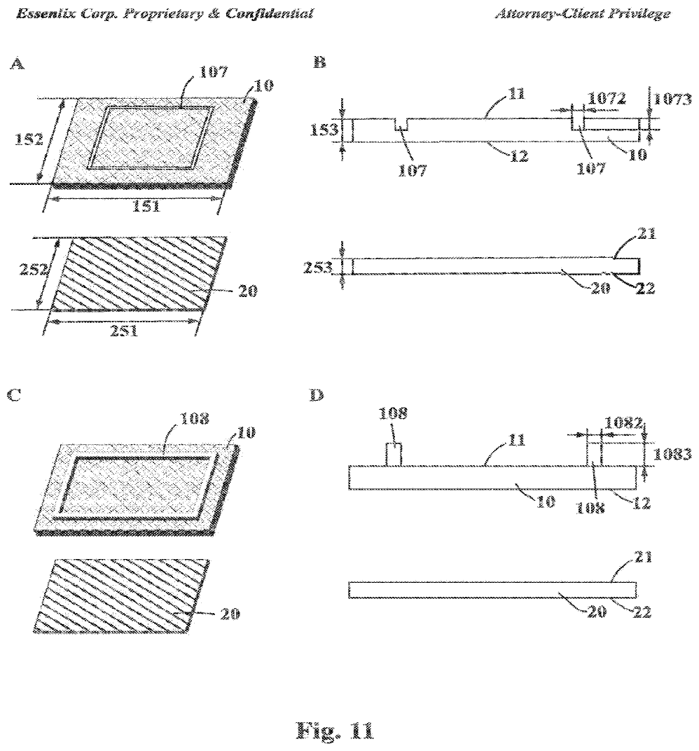

FIG. 11 shows two exemplary embodiments of the QMAX device, which comprises a first plate 10, a second plate 20, and an overflow prevention mechanism (an anti-overflow trench 107 or a wall 108). As discussed above, the plates are movable relative to each other into different configurations; one or both plates are flexible; each of the plates has, on its respective inner surface 11 and 21, a sample contact area (not indicated) for contacting a liquid sample.

In particular, in panels (A) and (B), the anti-overflow trench 107 is recessed into the first plate 10 and surrounds the sample contact area (partially or completely in particular embodiments). As discussed above, in some embodiments, during the transition of the plates from the open configuration to the closed configuration, the deposited sample is compressed and such a compression leads to deformation of the sample into a thin layer. The reduction in thickness of the sample is certainly accompanied and achieved by the expansion of its lateral dimension (as known as the “open flow” if the sample is liquidous). Therefore, in certain embodiments, there is a chance that, undesirably, the sample may flow to the outside of the sample contact area, or even to the outside of the plates. The function of the anti-overflow trench 107, as provided herein, is to prevent such an overflow of the liquid sample. It should be noted, in some embodiments, the anti-overflow trench is recessed into the second plate, or both plates. In some embodiments, there are more than one anti-overflow trench on one plate.

Panels (C) and (D) show the QMAX device has an anti-overflow wall 108 fixed on the first plate inner surface 11, forming an enclosure of the sample contact area as its overflow prevention mechanism. It should be noted, in some embodiments, the anti-overflow wall is fixed on the second plate, or both plates. In some embodiments, there are more than one anti-overflow wall on one plate.

In some embodiments, the device has both anti-overflow trench(es) and anti-overflow wall(es) for the overflow prevention. The dimensions and spatial relationship of the anti-overflow trench(es) and anti-overflow wall(s) are configured to maximize the prevention of the overflow of the sample.

The anti-overflow trench 107 and the anti-overflow wall 108 in the figure both have a rectangular shape and are conductively-closed. However, it is also possible that, in other embodiments, the anti-overflow trench or the anti-overflow wall is a closed belt in a shape such as, but not limited to, circle, triangle, round, elliptical, polygon, or any superposition of these shapes. The anti-overflow trench or wall can have any possible cross-sectional shape as well, which is either uniform or not uniform. It is also possible that, in some embodiments, the anti-overflow trench is open instead of closed, and in some embodiments, the anti-overflow wall does not form an enclosure. In these embodiments, the anti-overflow trench or wall is in a shape such as straight line, curved line, arc, branched tree, or any other shape with open endings. In some particular embodiments, the anti-overflow trench or the anti-overflow wall is designed to be on only one or more sides of the sample contact area, which is/are known or predicted to be where the sample tends to overflow to.

As shown in the figure, the volume of the anti-overflow trench 107 is determined by its lateral dimensions (length or perimeter in the case of a closed anti-overflow trench, and cross-sectional width 1062) and thickness 1063. Certainly, the depth 1063 is smaller than the thickness of the first plate 153 so that the anti-overflow trench is a through hole on the plate. The exact dimensions of the anti-overflow trench is configured so that the anti-overflow trench has a predetermined volume that is larger than an expected overflow volume of the sample, which is the expected volume of the sample that flows to outside of the sample contact areas at the closed configuration of the two plates.

Similar to the anti-overflow trench, the lateral dimensions (length or perimeter in the case of a closed anti-overflow trench, and cross-sectional lateral width 1082) and height 1083 of the anti-overflow wall 108 are also configured to serve its function as to prevent the sample to flow to the outside of the sample contact areas at the closed configuration of the two plates.

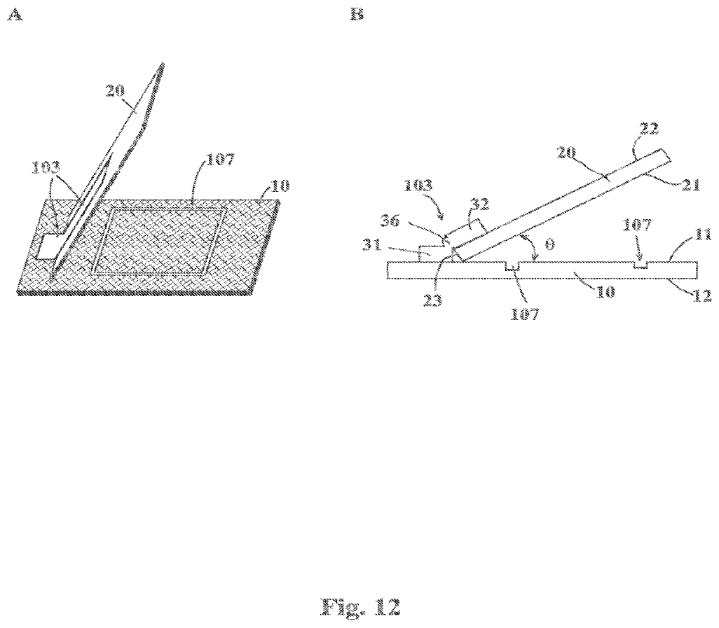

FIG. 12 shows another exemplary embodiment of the QMAX device, which comprises a first plate 10, a second plate 20, and an anti-overflow trench 107. The plates are connected through a hinge 103 that comprises a first leaf 31, a second leaf 32 and a hinge joint 36. As discussed above, the plates are movable relative to each other into different configurations; one or both plates are flexible; each of the plates has, on its respective inner surface 11 and 21, a sample contact area (not indicated) for contacting a liquid sample. In particular, the anti-overflow trench 107 is recessed into the first plate 10, surrounds the sample contact area (partially or completely in particular embodiments) for sample overflow prevention as discussed above.

### 16. QMAX Device without Hinge

It should be noted that in some embodiments of the QMAX device, as shown in FIG. 11, there is no hinge connecting the first plate 10 and the second plate 20. The two plates are separated apart completely at the open configuration, and brought to each other to enter the closed configuration.

### 17. Sliding Track and Plate Pair

In some embodiments, the QMAX device or card is inserted to an adaptor for sample analysis. The adaptor comprises a receptacle slot for receiving and positioning the closed QMAX device for imaging. In some embodiments, the receptacle slot comprises a sample slider that is mounted inside the receptacle slot to receive the QMAX device and position the sample in the QMAX device in the field of view and focal range of the imaging device. The sample slider comprises a sliding track configured to engage the closed QMAX device and allow the engaged QMAX device to slide back and forth along the sliding track. The term “slide” as used herein refers to the action of the QMAX device moving along while being in continuous contact with and geologically confined within a sliding track.

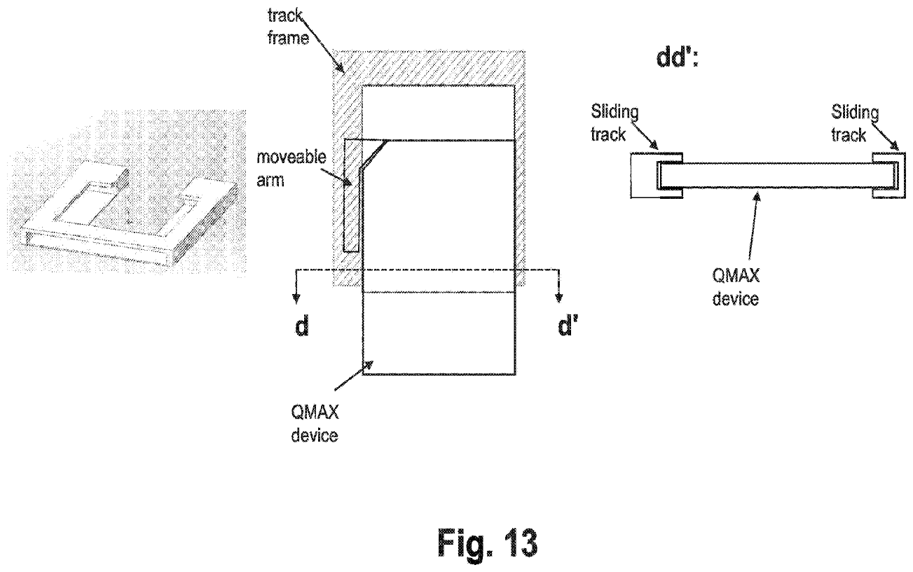

FIG. 13 shows schematically the structure of an exemplary sample slider holding a QMAX device (left: perspective view, center: top view with inside details, right: cross-sectional view of section dd′). The sample slider comprises a track frame having a sliding track for QMAX device to slide along it, and a movable arm pre-installed inside the sliding track to be moved together with and guide the QMAX device. In some embodiments. the movable arm is equipped with a stopping mechanism to render the QMAX device to stop at two or more pre-defined stop positions. In some embodiments, the width and height of the track slot is carefully configured to make sure that the QMAX device shifts less than 0.5 mm in horizontal direction perpendicular to the sliding direction and less than 0.2 mm along the thickness direction of the QMAX device. In some embodiments, the shift along either direction is maintained be less than 5 mm, 2 mm, 1 mm, 0.5 mm, 0.25 mm, 0.2 mm, 0.1 mm, 0.05 mm, 0.01 mm, 0.005 mm, 0.001 mm, or within a range of any two of these values.

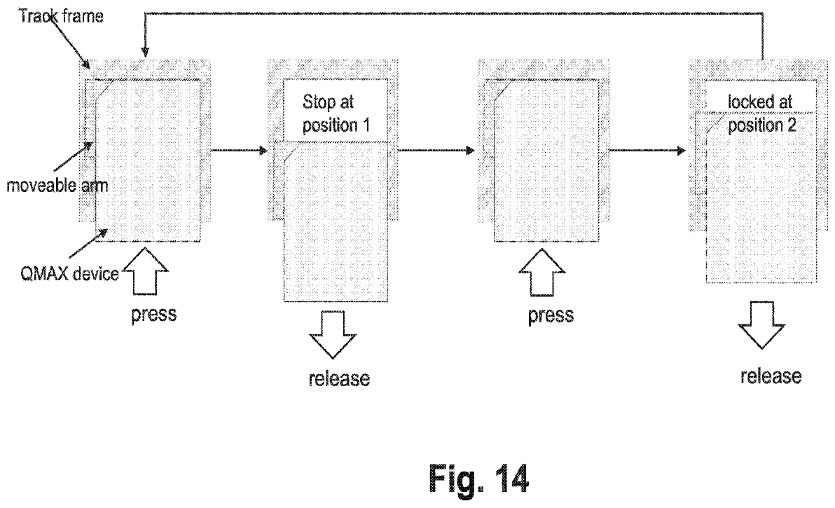

FIG. 14 is a schematic illustration of the movable arm switching between two pre-defined stop positions according to some exemplary embodiments. By pressing the QMAX device and the movable arm together to the end of the track slot and then releasing, the QMAX card can stop at either position 1 where sample area is out of field of view of smartphone camera for easily taking out the QMAX device from the slider or position 2 where sample area is right under the field of view of smartphone camera for capturing image.

In some embodiments, for easy operation, especially the ease of sliding the closed QMAX card into and out of the adaptor, it is necessary to include certain desirable features in the device.

In some cases, the device is designed to have recessed edge(s) on one of the plates as described above. As shown in FIGS. 1, 2, 3, 5, and 10, in some embodiments, one of the plates, e.g. the second plate 20, can be recessed on the edges to the corresponding edge of the other plate, e.g. the first plate 10. In certain embodiments, there are one, two, three, or four recessed edges of one plate compared to the adjacent parallel edges on the other plate.

The width of the recess (e.g. recess 154 or recess 152) can vary. In some embodiments, the width of the recess is less than 1/100, 1/50, 1/24, 1/12, 1/10, 1/9, ⅛, ⅙, ⅕, ¼, ⅓, ½, or ⅔ of the width of the recessed plate, or in a range between any of the two values. In some embodiments, the width of the recess is less than 1 um, 10 um, 20 um, 30 um, 40 um, 50 um, 100 um, 200 um, 300 um, 400 um, 500 um, 7500 um, 1 mm, 5 mm, 10 mm, 100 mm, or 1000 mm, or in a range between any of the two values.

In some cases, particularly when the two plates are not connected by a hinge, as shown in FIG. 11, the first plate 10 has relatively larger lateral dimensions (in this case, longer side lengths 151 and 152 as compared 251 and 252) and a thickness 153 that is relatively larger than that of the second plate 20 (253). And in some cases, the larger and thicker plate is also relatively harder than the other. In some embodiments, the average lateral dimension difference between the two plates is about 0.5% or less, 1% or less, 2% or less, 5% or less, 10% or less, 15% or less, 20% or less, 30% or less, 40% or less, 50% or less, 60% or less, 70% or less, 80% or less, 90% or less, 95% or less, 99% or less or within a range of any two of these values. In some embodiments, the average lateral dimension difference between the two plates is 1 um or less, 10 um or less, 20 um or less, 30 um or less, 40 um or less, 50 um or less, 100 um or less, 200 um or less, 300 um or less, 400 um or less, 500 um or less, 7500 um or less, 1 mm or less, 5 mm or less, 10 mm or less, 100 mm or less, or 1000 mm or less, or in a range between any of the two values. In some embodiments, the average thickness difference between the two plates is 2 nm or less, 10 nm or less, 100 nm or less, 200 nm or less, 500 nm or less, 1000 nm or less, 2 μm (micron) or less, 5 μm or less, 10 μm or less, 20 μm or less, 50 μm or less, 100 μm or less, 150 μm or less, 200 μm or less, 300 μm or less, 500 μm or less, 800 μm or less, 1 mm (millimeter) or less, 2 mm or less, 3 mm or less, or in a range between any two of the values.

In some embodiments, the foregoing features of the QMAX device ensure, among others, the following operational advantages. (1) One can easily bring the two plates into a complete overlap when pressing the plates to enter the closed configuration, through laying the relatively smaller, thinner/softer plate on the bigger and thicker plate and within the border of the latter and pressing the two plates, with no need to finely adjust the relative position of the two plates. The complete overlap of the closed two plates means that the lateral dimension of the closed plates equates to the maximum dimension of the two plates, to which the sliding track of the adaptor is designed to fit. Therefore, even in the absence of a hinge fixating the relative position of the two plates, one can easily make sure the closed plates fit the predesigned adaptor; (2) During the insertion of the closed plates into the adaptor, the relatively thicker and/or harder plate can serve as a guide for the docking of the plates to the sliding track and the sliding movement inside the track without causing the closed plates to open or deform.

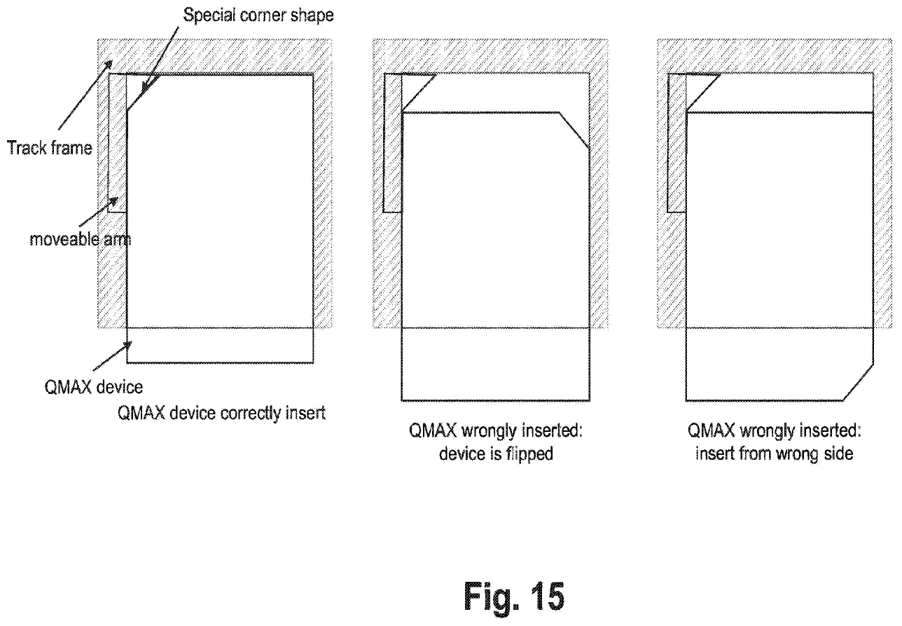

In other cases, as shown in FIGS. 13, 14, and 15, the shape of one corner of the QMAX device is configured to be different from the other three right angle corners, and the shape of the movable arm of the sample slider matches the shape of the corner with the special shape so that only in correct direction can QMAX device slide to correct position in the track slot. Such a combinatory feature of both the QMAX device and the sample slider ensures the correct insertion direction. As shown in FIG. 15, if the QMAX device is flipped or inserted from the wrong side, it is easy for the operator to notice that the QMAX device extends outside the slider for a longer distance than that when the QMAX device is correctly inserted.

### 18. Dimension of QMAX Card

As discussed above, the thickness, width, and/or length of the two (or more) plates of the QMAX card can be the same or different.

### Shape of the Card:

In some embodiments, the shape of the two plates is round, ellipse, rectangle, triangle, polygonal, ring-shaped, or any superposition of these shapes.

In some embodiments, the two (or more) plates of the QMAX card can have the same size and/or shape, or different size and/or shape.

In some embodiments, at least one of the two (or more) plates of the QMAX card has round corners for user safety concerns, wherein the round corners have a diameter of 100 um or less, 200 um or less, 500 um or less, 1 mm or less, 2 mm or less, 5 mm or less, 10 mm or less, 50 mm or less, or in a range between any two of the values.

Generally, the plates can have any shapes, as long as the shape allows a compress open flow of the sample and the regulation of the sample thickness. However, in some embodiments, a particular shape is advantageous.

### Thickness of the Card:

The thickness, width, and/or length of the two (or more) plates of the QMAX card can be the same or different.

In some embodiments, the average thickness for at least one of the plates is 2 nm or less, 10 nm or less, 100 nm or less, 200 nm or less, 500 nm or less, 1000 nm or less, 2 μm (micron) or less, 5 μm or less, 10 μm or less, 20 μm or less, 50 μm or less, 100 μm or less, 150 μm or less, 200 μm or less, 300 μm or less, 500 μm or less, 800 μm or less, 1 mm (millimeter) or less, 2 mm or less, 3 mm or less, 5 mm or less, 10 mm or less, 20 mm or less, 50 mm or less, 100 mm or less, 500 mm or less, or in a range between any two of the values.

In some embodiments, the thickness of at least one of the plates is in the range of 0.5 to 1.5 mm;

In some embodiment, the thickness of at least one of the plates is around 1 mm.

In some embodiments, the thickness of at least one of the plates is in the range of 0.15 to 0.2 mm.

In some embodiment, the thickness of at least one of the plates is around 0.175 mm.

In some embodiment, the thickness of the plates is around 0.175 m and the other plate is 0.05 mm or less.

In some embodiments, the thickness of at least one of the plates is in the range of 0.01 to 0.15 mm.

In some embodiment, the thickness of at least one of the plates is around 0.025 mm or less.

In some embodiment, the thickness of at least one of the plates is around 0.05 mm or less.

In some embodiment, the thickness of at least one of the plates is around 0.1 mm or less.

In some embodiment, the thickness of both plates is around 0.1 mm or less.

In some embodiment, the thickness of both plates is around 0.05 mm or less.

In some embodiments, the thickness of any one of the plates is not uniform across the plate. Employing a different plate thickness at different location can be used to control the plate bending, folding, sample thickness regulation, and others.

### Area, Width and Length of the Card:

The area of any one of the plates depends on the specific application.

In some embodiments, the area of at least one of the plate is 1 mm² (square millimeter) or less, 10 mm² or less, 25 mm² or less, 50 mm² or less, 75 mm² or less, 1 cm² (square centimeter) or less, 2 cm² or less, 3 cm² or less, 4 cm² or less, 5 cm² or less, 10 cm² or less, 100 cm² or less, 500 cm² or less, 1000 cm² or less, 5000 cm² or less, 10,000 cm² or less, 10,000 cm² or less, or in a range between any of the two values.

In some embodiments, the area of at least one plate of the QMAX card is in the range of 500 to 1000 mm²;

In some embodiments, the area of one plate is around 600 mm² and the area of another plate is around 750 mm².

In some embodiments, the width of at least one of the plates of the QMAX card is 1 mm or less, 5 mm or less, 10 mm or less, 15 mm or less, 20 mm or less, 25 mm or less, 30 mm or less, 35 mm or less, 40 mm or less, 45 mm or less, 50 mm or less, 100 mm or less, 200 mm or less, 500 mm or less, 1000 mm or less, 5000 mm or less, or in a range between any of the two values.

In some embodiments, the width of at least one plate of the QMAX card is in the range of 20 to 30 mm;

In some embodiments, the width of one plate is around 22 mm and the width of another plate is around 24 mm.

In some embodiments, the length of at least one of the plates of the QMAX card is 1 mm or less, 5 mm or less, 10 mm or less, 15 mm or less, 20 mm or less, 25 mm or less, 30 mm or less, 35 mm or less, 40 mm or less, 45 mm or less, 50 mm or less, 100 mm or less, 200 mm or less, 500 mm or less, 1000 mm or less, 5000 mm or less, or in a range between any of the two values.

In some embodiments, the length of at least one plate of the QMAX card is in the range of 20 to 40 mm;

In some embodiments, the length of one plate is around 27 mm and the length of another plate is around 32 mm.

### Notch:

In some embodiments, there is a notch or multi notches on side of one of the plate for easily peeling up the other plate and separate two plates.

In some embodiments, the shape of the notch is round, ellipse, rectangle, triangle, polygon, ring-shaped, or any superposition of these shapes.

In some embodiments, the size of the notch is 1 mm² (square millimeter) or less, 10 mm² or less, 25 mm² or less, 50 mm² or less, 75 mm² or less or in a range between any of the two values.

In some embodiments, the area of each notch on the QMAX card is in the range of 10 to 30 mm².

In some embodiments, the notch is half-round shape with a diameter of 3 to 6 mm.

In some embodiments, the notch has a width of 3 mm and a length of 6 mm.

In some embodiments, the notch locates at the short width side on the thicker plate.

In some embodiments, the two notches locate at the two long width side on the thicker plate.

### Hinge:

In some embodiments, the size of the hinge vary and can be adjusted according to the size of the plates and the specific needs of the application for the device.

In some embodiments, the shape of the hinge is round, ellipse, rectangle, triangle, polygon, ring-shaped, or any superposition of these shapes.

In some embodiments, the length of the hinge joint is less than 1 mm, 2 mm, 3 mm, 4 mm, 5 mm, 10 mm, 15 mm, 20 mm, 25 mm, 30 mm, 40 mm, 50 mm, 100 mm, 200 mm, or 500 mm, or in a range between any of the two values.

In some embodiments, the length of the hinge joint is around 20 mm.

In some embodiments, the width of the hinge joint is less than 1 mm, 2 mm, 3 mm, 4 mm, 5 mm, 10 mm, 15 mm, 20 mm, 25 mm, 30 mm, 40 mm, 50 mm, 100 mm, 200 mm, or 500 mm, or in a range between any of the two values.

In some embodiments, the width of the hinge joint is around 6 mm.

In some embodiments, the ratio of the length of the hinge joint to the length of the plate edge with which the hinge joint 36 is aligned is less than 1.5, 1, 0.9, 0.8, 0.7, 0.6, 0.5, 0.4, 0.3, 0.2, 0.1, 0.05 or in a range between any two of these values.

In one embodiment, the ratio of the length of the hinge joint to the length of the plate edge with which the hinge joint 36 is aligned is 1, indicating that the hinge joint completely covers the hinge edge.

In some embodiments, the overall area of the hinge is less than 1 mm², 5 mm², 10 mm², 20 mm², 30 mm², 40 mm², 50 mm², 100 mm², 200 mm², 500 mm², or in a range between any of the two values.

In some embodiments, the overall area of the hinge is around 120 mm².

In some embodiments, the ratio of the overall size of the hinge to the overall size of one of the plates is less than 1, 0.9, 0.8, 0.7, 0.6, 0.5, 0.4, 0.3, 0.2, 0.1, 0.05, 0.01 or in a range between any two of these values.

In some embodiments, the ratio of the overall size of the hinge to the overall size of one of the plates is around 0.16 to 0.20.

The different layers of the hinge has the same or different thickness. In some embodiments, any layer of the hinge have a thickness in 0.1 um, 1 um, 2 um, 3 um, 5 um, 10 um, 20 um, 30 um, 50 um, 100 um, 200 um, 300 um, 500 um, 1 mm, 2 mm, and a range between any two of these values

In one embodiment, any of the layers of hinge has a thickness in the range of 25 μm to 50 μm.

In one embodiment, any of the layers of hinge has a thickness in the range of 50 μm to 75 μm.

In one embodiment, any of the layers of hinge has a thickness around 68 μm.

### Receptacle Slot:

In some embodiments, the receiving area of the receptacle slot, or the lateral area covered by the sliding track has an area larger or equal as the area of the QMAX device.

In some embodiments, the shape of the receiving area of the receptacle slot is round, ellipse, rectangle, triangle, polygon, ring-shaped, or any superposition of these shapes;

In some embodiments, the average gap size of the sliding track is larger than the average thickness of the device by 100 nm, 500 nm, 1 um, 2 um, 5 um, 10 um, 50 um, 100 um, 300 um, 500 um, 1 mm, 2 mm, 5 mm, 1 cm, or in a range between any two of the values.

In some embodiments, the average gap size of the slot is larger than the average thickness of the device by 50 um to 300 um.

In some embodiments, the receiving area of the receptacle slot is larger than the area of the device by 1 mm² (square millimeter) or less, 10 mm² or less, 25 mm² or less, 50 mm² or less, 75 mm² or less, 1 cm² (square centimeter) or less, 2 cm² or less, 3 cm² or less, 4 cm² or less, 5 cm² or less, 10 cm² or less, 100 cm² or less, or in a range between any of the two values.

In some embodiments, the shape of one of the plates or both of the plates is the same as the shape of the receptacle slot.

In one embodiments, the receptacle slot has a shape of box with one open surface, with a length of 31 mm, a width of 27 mm and a height of 2.5 mm.

In some embodiments, the QMAX device is only partially inside the receptacle slot at best when they are fully engaged, the shape of part of one of the plates or both of the plates is the same as the shape of the receptacle slot.

### Others:

In some embodiments, at least one of the plate is in the form of a belt (or strip) that has a width, thickness, and length. In some embodiments, the width is at most 0.1 cm (centimeter), at most 0.5 cm, at most 1 cm, at most 5 cm, at most 10 cm, at most 50 cm, at most 100 cm, at most 500 cm, at most 1000 cm, or in a range between any two of the values. The length is as long it needed. In some embodiments, the belt is rolled into a roll.

### 19. Disposable Cards

In some embodiments, it is a significant advantage of the present invention that the disclosed QMAX cards are made of inexpensive materials and manufactured with low cost, therefore the economic burden to the user is at relatively low level.

In some embodiments, the QMAX cards are configured to be disposable after one-time use.

In some embodiments, the QMAX cards are configured to be environmentally safe and therefore its disposal does not need special treatment. In one aspect, none of the materials for a basic QMAX card (the plates and/or the hinge) as provided herein in some embodiments, are known to be toxic or dangerous to human beings or the environment. In another aspect, the round corner designed for the plates in some embodiments are particularly useful for avoiding unintentional stabbing or slashing injury either to the user or to other people that may have exposure to them, including trash collectors. Moreover, the overflow prevention mechanism in certain embodiments are useful for preventing the unintentional contact with or exposure to the biological and/or chemical sensitive sample material that is deposited in between the plates.

### 20. Example of QMAX-Card with Aluminum and Glue Hinge

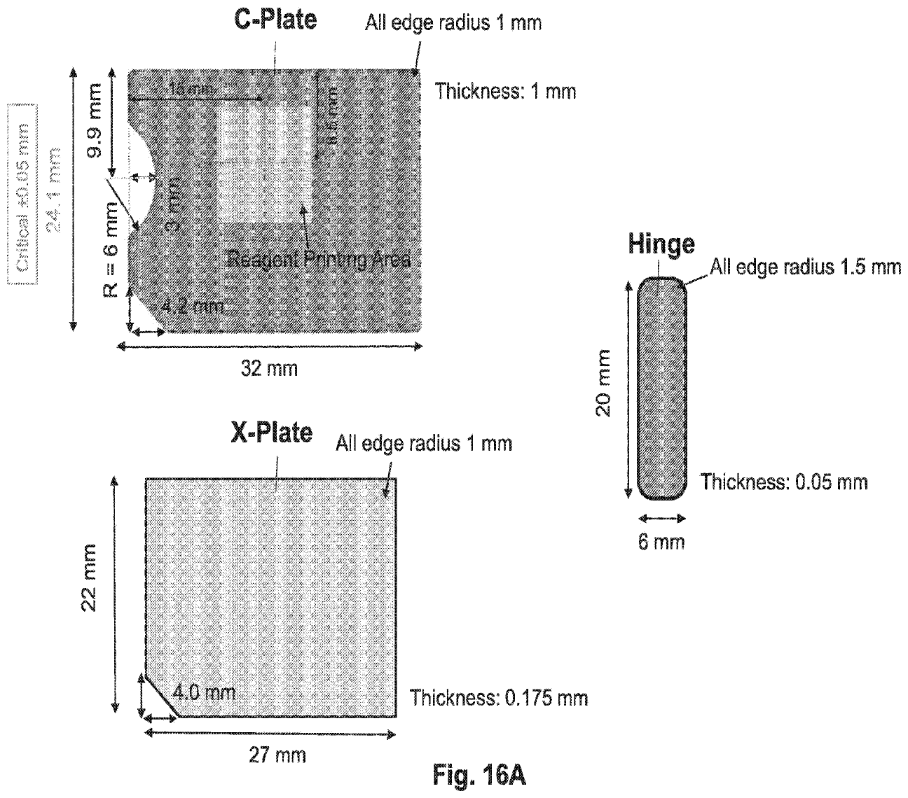

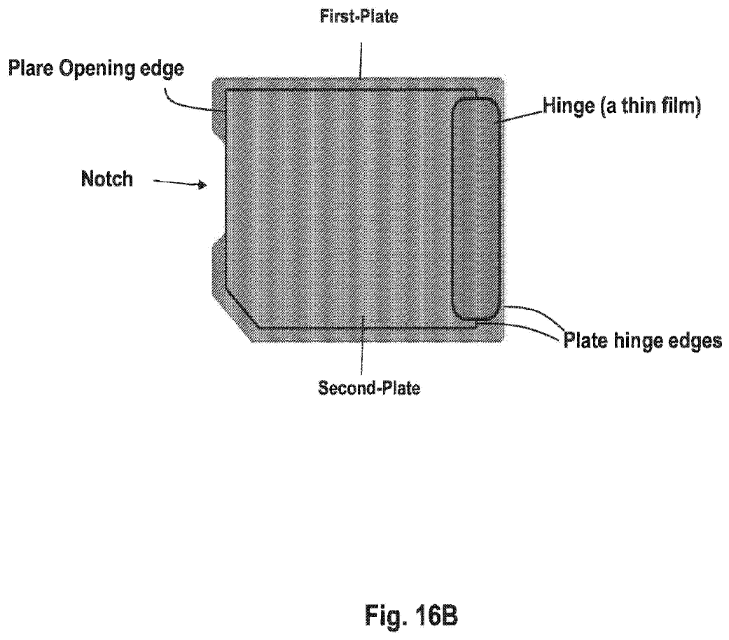

FIGS. 16A and 16B show top views of an exemplary embodiment of the QMAX card. The QMAX card comprises a C-Plate, an X-Plate, and a hinge. The design of the exemplary QMAX card includes several features for easy operation, including: 1) a notch, rounded corners, and a recessed corner of the C-plate; 2) a recessed corner and four recessed edges of the X-plate; and 3) an angel self-maintaining hinge made of one layer of aluminum foil and one layer of acrylic adhesive. In this particular example, the C-plate also has a reagent printing area where reagent is printed for bio/chemical assay.

FIG. 16A shows the dissembled individual components of the device and the specific dimensions and measurement of the C-plate, the X-plate and the hinge, as well as that of the notch. For example, when applied in the QMAX card, the hinge has a size of 6 mm×20 mm, with 1.5 mm radius round edges.

FIG. 16B shows a top view of the assembled exemplary QMAX card. The configuration of this QMAX card is similar to that shown in FIG. 5, in that the hinge is positioned so that one of its leaves is attached to the inner surface (not indicated) of the C-plate, its other leaf is attached to the outer surface (not indicated) of the X-plate, and the hinge joint is positioned longitudinally parallel to the hinge edge of the two plates, allowing the two plates to pivot against each other and switch between an open configuration and a closed configuration. The hinge aligned with, but do not wrap around any of the plate edges. Moreover, the two plates are positioned so that all the edges of X-plate are within the border of the C-plate (“recessed”) and the opening edge of the X-plate is partially juxtaposed over the notch.

In certain embodiments, the thickness of the aluminum foil (as exemplified in FIGS. 16A and 16B) is 30-40 μm (e.g. about 35 μm); in certain embodiments, the thickness of the acrylic adhesive layer is 30-40 μm (e.g. about 33 μm). In one particular embodiment, the aluminum foil (3M™ Metal Foil Tapes, product number 3381) is 35 μm thick and the acrylic adhesive layer is 33 μm thick, giving the hinge a total thickness of 68 μm.

### 21. Example of Sample Slider and QMAX Device

In an exemplary embodiment of a combination of a sample slider and a QMAX device, which has the track frame, sliding track, and QMAX device (this device is similar a memory card slides into a slot of an electronic device). In particular, the gap of the sliding track is 1.25 mm, while the thickness of the QMAX device is 1.175 mm, 0.075 mm shorter than the gap; the receiving length of the sliding track is 24.5 mm, while the length of the engaging side of the QMAX device (the side of the device facing the slot while the device being inserted into the slot) is 24 mm, 0.5 mm shorter than the receiving length. These small dimensional differences provide favorable mechanic advantages: on one hand, the QMAX device can slide smoothly inside the sliding track; on the other hand, the positioning of the QMAX device inside the receptacle slot is still accurate with only small variations. It is to be noted, to what extent such variation is tolerable depends on the ultimate purpose of using the QMAX device and the sample slider.

### 22. QMAX Assay and Device in Detail

The following descriptions relate to the plates and the spacers as shown in FIG. 1. The elements of these descriptions are also combined with the features as shown in FIGS. 2-8 and described thereof.
Open Configuration. In some embodiments, in the open configuration, the two plates (i.e. the first plate and the second plate) are separated from each other. In certain embodiments, the two plates have one edge connected together during all operations of the plates (including the open and closed configuration), the two plates open and close similar to a book. In some embodiments, the two plates have rectangle (or square) shape and have two sides of the rectangles connected together (e.g. with a hinge or similar connector) during all operations of the plates.

In some embodiments, the open configuration is a configuration that the plates are far away from each other, so that the sample is deposited onto one plate of the pair without any hindrance of the other plate. In some embodiments, when two sides of the plates are connected, the open configuration is a configuration that the plates form a wide angle (e.g. in the range of 60 to 180, 90 to 180, 120 to 180, or 150 to 180 degrees) so that the sample is deposited onto one plate of the pair without any hindrance of the other plate.

In some embodiments, the open configuration comprises a configuration that the plates are far way, so that the sample is directly deposited onto one plate, as if the other plate does not exist.

In some embodiments, the open configuration is a configuration that the pair of the plates are spaced apart by a distance at least 10 nm, at least 100 nm, at least 1000 nm, at least 0.01 cm, at least 0.1 cm, at least 0.5 cm, at least 1 cm, at least 2 cm, or at least 5 cm, or a range of any two of the values.

In some embodiments, the open configuration is a configuration that the pair of plates are oriented in different orientations. In some embodiments, the open configuration comprises a configuration that defines an access gap between the pair of plates that is configured to permit sample addition.

In some embodiments, the open configuration comprises a configuration, wherein each plate has a sample contact surface and wherein at least one of the contact surfaces of the plates is exposed when the plates are in the open configuration.
Closed Configuration and Sample Thickness Regulation. In some embodiments, a closed configuration of the two plates is the configuration that a spacing (i.e. the distance) between the inner surfaces of the two plates is regulated by the spacers between the two plates. In some embodiments, the closed configuration is not related to whether the sample has been added to the plates. In some embodiments, the spacing between the inner surfaces of the two plates is substantially uniform and similar to the uniform height of the spacers.

Since the inner surfaces (also termed “sample surface”) of the plates are in contact with the sample during the compression step of a QMAX process after the sample has been added, in some embodiments at the closed configuration, the sample thickness is regulated by the spacers.

During the process of bringing the plates from an open configuration to a closed configuration, the plates are facing each other (at least a part of the plates are facing each other) and a force is used to bring the two plates together. If a sample has been deposited, when the two plates are brought from an open configuration to a closed configuration, the inner surfaces of the two plates compress the sample deposited on the plate(s) to reduce the sample thickness (while the sample has an open flow laterally between the plates), and the thickness of a relevant volume of the sample is determined by the spacers, the plates, and the method being used and by the sample mechanical/fluidic property. The thickness at a closed configuration is predetermined for a given sample and given spacers, plates and plate pressing method.

The term “regulation of the spacing between the inner surfaces of the plates by the spacers” or “the regulation of the sample thickness by the plates and the spacer”, or a thickness of the sample is regulated by the spacers and the plates” means that the spacing between the plates and/or the thickness of the sample in a QMAX process is determined by given plates, spacers, sample, and pressing method.

In some embodiments, the regulated spacing between the inner surfaces and/or regulated sample thickness at the closed configuration is the same as the height of a spacer or the uniform height of the spacers; in this case, at the closed configuration, the spacers directly contact both plates (wherein one plate is the one that the spacer is fixed on, and the other plate is the plate that is brought to contact with the spacer).

In certain embodiments, the regulated spacing between the inner surfaces and/or regulated sample thickness at the closed configuration is larger than the height of a spacer; in this case, at the closed configuration, the spacers directly contacts only the plate that has the spacers fixed or attached on its surface, and indirectly contact the other plate (i.e. indirect contact). The term “indirect contact” with a plate means that the spacer and the plate is separated by a thin layer of air (when no sample has been deposited) or a thin sample layer (when a sample has been deposited), which is termed “residual layer” and its thickness is termed “the residue thickness”. For given spacers and plates, a given plate pressing method, and a given sample, the residual thickness is predetermined (predetermined means prior to reach the closed configuration), leading to a predetermination of the sample thickness at the closed configuration. This is because the residue layer thickness is the same for the given conditions (the sample, spacers, plates, and pressing force) and is pre-calibrated and/or calculated. The regulated spacing or the regulated sample thickness is approximately equal to the spacer height plus the residue thickness.

In many embodiments, the spacers have a pillar shape and the size and shape of the pillars are pre-characterized (i.e. pre-determined) before their use. And the pre-determined parameters are used to for later assaying, such as determination of the sample volume (or relevant volume) and others.

In some embodiments, the regulating of the spacing between the inner surfaces and/or the sample thickness includes applying a closing (compression) force to the plates to maintain the spacing between the plates.

In some embodiments, the regulating of the spacing between the inner surfaces and/or the sample thickness includes establishing the spacing between the plates with the spacers, a closing force applied to the plates, and physical properties of the sample, and optionally wherein the physical properties of the sample include at least one of viscosity and compressibility.
Plates. In the present invention, generally, the plates of QMAX are made of any material that (i) is capable of being used to regulate, together with the spacers, part of all of the spacing between the plates and/or the thickness of a portion or entire volume of the sample, and (ii) has no significant adverse effects to a sample, an assay, or a goal that the plates intend to accomplish. However, in certain embodiments, particular materials (hence their properties) are used for the plate to achieve certain objectives.

In some embodiments, the two plates have the same or different parameters for each of the following parameters: plate material, plate thickness, plate shape, plate area, plate flexibility, plate surface property, and plate optical transparency.
Plate materials. In some embodiments, the plates are made a single material, composite materials, multiple materials, multilayer of materials, alloys, or a combination thereof. Each of the materials for the plate is an inorganic material, am organic material, or a mix, wherein examples of the materials are given in embodiments of Mat-1 and Mat-2.
Mat-1. The inorganic materials for any one of the plates include, but not limited to, glass, quartz, oxides, silicon-dioxide, silicon-nitride, hafnium oxide (HfO), aluminum oxide (AlO), semiconductors: (silicon, GaAs, GaN, etc.), metals (e.g. gold, silver, copper, aluminum, Ti, Ni, etc.), ceramics, or any combinations of thereof.
Mat-2 The organic materials for any one of the plates include, but not limited to, polymers (e.g. plastics) or amorphous organic materials. The polymer materials for the plates include, not limited to, acrylate polymers, vinyl polymers, olefin polymers, cellulosic polymers, noncellulosic polymers, polyester polymers, Nylon, cyclic olefin copolymer (COC), poly(methyl methacrylate) (PMMA), polycarbonate (PC), cyclic olefin polymer (COP), liquid crystalline polymer (LCP), polyamide (PA), polyethylene (PE), polyimide (PI), polypropylene (PP), poly(phenylene ether) (PPE), polystyrene (PS), polyoxymethylene (POM), polyether ether ketone (PEEK), polyether sulfone (PES), poly(ethylene phthalate) (PET), polytetrafluoroethylene (PTFE), polyvinyl chloride (PVC), polyvinylidene fluoride (PVDF), polybutylene terephthalate (PBT), fluorinated ethylene propylene (FEP), perfluoroalkoxyalkane (PFA), polydimethylsiloxane (PDMS), rubbers, or any combinations of thereof.

In some embodiments, the plates are each independently made of at least one of glass, plastic, ceramic, and metal. In some embodiments, each plate independently includes at least one of glass, plastic, ceramic, and metal.

In some embodiments, one plate is different from the other plate in lateral area, thickness, shape, materials, or surface treatment. In some embodiments, one plate is the same as the other plate in lateral area, thickness, shape, materials, or surface treatment.

The materials for the plates are rigid, flexible or any flexibility between the two. The rigidity (i.e. stiff) or flexibility is relative to a give pressing forces used in bringing the plates into the closed configuration.

In some embodiments, a selection of rigid or flexible plate is determined from the requirements of controlling a uniformity of the sample thickness at the closed configuration.

In some embodiments, at least one of the two plates are transparent (to a light). In some embodiments at least a part or several parts of one plate or both plates are transparent. In some embodiments, the plates are non-transparent.
Plate Thickness. In some embodiments, the average thickness for at least one of the plates is 2 nm or less, 10 nm or less, 100 nm or less, 200 nm or less, 500 nm or less, 1000 nm or less, 2 μm (micron) or less, 5 μm or less, 10 μm or less, 20 μm or less, 50 μm or less, 100 μm or less, 150 μm or less, 200 μm or less, 300 μm or less, 500 μm or less, 800 μm or less, 1 mm (millimeter) or less, 2 mm or less, 3 mm or less, or in a range between any two of the values.

In some embodiments, the average thickness for at least one of the plates is at most 3 mm (millimeter), at most 5 mm, at most 10 mm, at most 20 mm, at most 50 mm, at most 100 mm, at most 500 mm, or in a range between any two of the values.

In some embodiments, the average thickness for at least one of the plates is in the range of 1 to 1000 μm, 10 to 900 μm, 20 to 800 μm, 25 to 700 μm, 25 to 800 μm, 25 to 600 μm, 25 to 500 μm, 25 to 400 μm, 25 to 300 μm, 25 to 200 μm, 30 to 200 μm, 35 to 200 μm, 40 to 200 μm, 45 to 200 μm, or 50 to 200 μm. In some embodiments, the average thickness for at least one of the plates is in the range of 50 to 75 μm, 75 to 100 μm, 100 to 125 μm, 125 to 150 μm, 150 to 175 μm, or 175 to 200 μm. In some embodiments, the average thickness for at least one of the plates is about 50 μm, about 75 μm, about 100 μm, about 125 μm, about 150 μm, about 175 μm, or about 200 μm.

In some embodiments, the thickness of a plate is not uniform across the plate. Using a different plate thickness at different location is used to control the plate bending, folding, sample thickness regulation, and others.
Plate Shape and Area. Generally, the plates can have any shapes, as long as the shape allows a compress open flow of the sample and the regulation of the sample thickness. However, in certain embodiments, a particular shape is advantageous. The shape of the plate is round, elliptical, rectangles, triangles, polygons, ring-shaped, or any superpositions of these shapes.

In some embodiments, the two plates can have the same size and/or shape, or different size and/or shape. The area of the plates depends on the specific application. In some embodiments, the area of the plate is at most 1 mm² (square millimeter), at most 10 mm², at most 100 mm², at most 1 cm² (centimeter square), at most 2 cm², at most 5 cm², at most 10 cm², at most 100 cm², at most 500 cm², at most 1000 cm², at most 5000 cm², at most 10,000 cm², or over 10,000 cm², or any range between any of the two values.

In certain embodiments, at least one of the plate is in the form of a belt (or strip) that has a width, thickness, and length. The width is at most 0.1 cm (centimeter), at most 0.5 cm, at most 1 cm, at most 5 cm, at most 10 cm, at most 50 cm, at most 100 cm, at most 500 cm, at most 1000 cm, or in a range between any two of the values. The length is as long it needed. The belt is rolled into a roll.
Plate surface flatness. In many embodiments, an inner surface of the plates is flat or significantly flat, planar. In certain embodiments, the two inner surfaces of the plates are, at the closed configuration, parallel with each other. Flat inner surfaces facilitate a quantification and/or controlling of the sample thickness by simply using the predetermined spacer height at the closed configuration. For non-flat inner surfaces of the plate, one need to know not only the spacer height, but also the exact the topology of the inner surface to quantify and/or control the sample thickness at the closed configuration. To know the surface topology needs additional measurements and/or corrections, which can be complex, time consuming, and costly.

The flatness of the plate surface is relative to the final sample thickness (the final thickness is the thickness at the closed configuration), and is often characterized by the term of “relative surface flatness,” which is the ratio of the plate surface flatness variation to the final sample thickness.

In some embodiments, the relative surface flatness is less than 0.01%, 0.1%, less than 0.5%, less than 1%, less than 2%, less than 5%, less than 10%, less than 20%, less than 30%, less than 50%, less than 70%, less than 80%, less than 100%, or in a range between any two of these values.
Plate surface parallelness. In some embodiments, the two surfaces of the plate are significantly parallel with each other in the closed configuration. Here “significantly parallel” means that an angle formed but extensions of the two plates is less than 0.1, 0.2, 0.5, 1, 2, 3, 4, 5, 10, or 15 degrees. In certain embodiments, the two surfaces of the plate are not parallel with each other.
Plate flexibility. In some embodiments, a plate is flexible under the compressing of a QMAX process. In some embodiments, both plates are flexible under the compressing of a QMAX process. In some embodiments, a plate is rigid and another plate is flexible under the compressing of a QMAX process. In some embodiments, both plates are rigid. In some embodiments, both plates are flexible but have different flexibility.
Plate optical transparency. In some embodiments, a plate is optically transparent. In some embodiments, both plates are optically transparent. In some embodiments, a plate is optically transparent and another plate is opaque. In some embodiments, both plates are opaque. In some embodiments, both plates are optically transparent but have different transparency. The optical transparency of a plate refers to a part or the entire area of the plate.
Plate surface wetting properties. In some embodiments, a plate has an inner surface that wets (i.e. contact angle is less 90 degree) the sample, the transfer liquid, or both. In some embodiments, both plates have an inner surface that wets the sample, the transfer liquid, or both; either with the same or different wettability. In some embodiments, a plate has an inner surface that wets the sample, the transfer liquid, or both; and another plate has an inner surface that does not (i.e. the contact angle equal to or larger than 90 degree). The wetting of a plate inner surface refers to a part or the entire area of the plate.

In some embodiments, the inner surface of the plate has other nano or microstructures to control a lateral flow of a sample during a QMAX. The nano or microstructures include, but not limited to, channels, pumps, and others. Nano and microstructures are also used to control the wetting properties of an inner surface.
Spacers' Function. In the present invention, the spacers are configured to have one or any combinations of the following functions and properties: the spacers are configured to (1) control, together with the plates, the spacing between the plates and/or the thickness of the sample for a relevant volume of the sample (Preferably, the thickness control is precise, or uniform or both, over a relevant area); (2) allow the sample to have a compressed regulated open flow (CROF) on plate surface; (3) not take significant surface area (volume) in a given sample area (volume); (4) reduce or increase the effect of sedimentation of particles or analytes in the sample; (5) change and/or control the wetting propertied of the inner surface of the plates; (6) identify a location of the plate, a scale of size, and/or the information related to a plate, and/or (7) do any combination of the above.
Spacer architectures and shapes. To achieve desired sample thickness reduction and control, in certain embodiments, the spacers are fixed on its respective plate. In general, the spacers have any shape, as long as the spacers are capable of regulating the spacing between the plates and the sample thickness during a QMAX process, but certain shapes are preferred to achieve certain functions, such as better uniformity, less overshoot in pressing, etc.

The spacer(s) is a single spacer or a plurality of spacers. (e.g. an array). Some embodiments of a plurality of spacers is an array of spacers (e.g. pillars), where the inter-spacer distance is periodic or aperiodic, or is periodic or aperiodic in certain areas of the plates, or has different distances in different areas of the plates.

There are two kinds of the spacers: open-spacers and enclosed-spacers. The open-spacer is the spacer that allows a sample to flow through the spacer (i.e. the sample flows around and pass the spacer. For example, a post as the spacer.), and the enclosed spacer is the spacer that stop the sample flow (i.e. the sample cannot flow beyond the spacer. For example, a ring shape spacer and the sample is inside the ring.). Both types of spacers use their height to regulate the spacing between the plates and/or the final sample thickness at a closed configuration.

In some embodiments, the spacers are open-spacers only. In some embodiments, the spacers are enclosed-spacers only. In some embodiments, the spacers are a combination of open-spacers and enclosed-spacers.

The term “pillar spacer” means that the spacer has a pillar shape and the pillar shape refers to an object that has height and a lateral shape that allow a sample to flow around it during a compressed open flow.

In some embodiments, the lateral shapes of the pillar spacers are the shape selected from the groups of (i) round, elliptical, rectangles, triangles, polygons, ring-shaped, star-shaped, letter-shaped (e.g. L-shaped, C-shaped, the letters from A to Z), number shaped (e.g. the shapes like 0 1, 2, 3, 4, . . . to 9); (ii) the shapes in group (i) with at least one rounded corners; (iii) the shape from group (i) with zig-zag or rough edges; and (iv) any superposition of (i), (ii) and (iii). For multiple spacers, different spacers can have different lateral shape and size and different distance from the neighboring spacers.

In some embodiments, the spacers are and/or include posts, columns, beads, spheres, and/or other suitable geometries. The lateral shape and dimension (i.e., transverse to the respective plate surface) of the spacers can be anything, except, in some embodiments, the following restrictions: (i) the spacer geometry will not cause a significant error in measuring the sample thickness and volume; or (ii) the spacer geometry would not prevent the out-flowing of the sample between the plates (i.e. it is not in enclosed form). But in some embodiments, they require some spacers to be closed spacers to restrict the sample flow.

In some embodiments, the shapes of the spacers have rounded corners. For example, a rectangle shaped spacer has one, several or all corners rounded (like a circle rather than a 90-degree angle). A round corner often makes a fabrication of the spacer easier, and in some cases less damaging to a biological material.

The sidewall of the pillars can be straight, curved, sloped, or different shaped in different section of the sidewall. In some embodiments, the spacers are pillars of various lateral shapes, sidewalls, and pillar-height to pillar lateral area ratio.

In a preferred embodiment, the spacers have shapes of pillars for allowing open flow.

In one embodiment, the spacers are made in the same material as a plate used in QMAX.
Spacer's mechanical strength and flexibility. In some embodiments, the mechanical strength of the spacers is strong enough, so that during the compression and at the closed configuration of the plates, the height of the spacers is the same or significantly the same as that when the plates are in an open configuration. In some embodiments, the differences of the spacers between the open configuration and the closed configuration can be characterized and predetermined.

The material for the spacers is rigid, flexible or any flexibility between the two. The rigid is relative to a give pressing forces used in bringing the plates into the closed configuration: if the space does not deform greater than 1% in its height under the pressing force, the spacer material is regarded as rigid, otherwise a flexible. When a spacer is made of material flexible, the final sample thickness at a closed configuration still can be predetermined from the pressing force and the mechanical property of the spacer.
Spacer inside Sample. To achieve desired sample thickness reduction and control, particularly to achieve a good sample thickness uniformity, in certain embodiments, the spacers are placed inside the sample, or the relevant volume of the sample. In some embodiments, there are one or more spacers inside the sample or the relevant volume of the sample, with a proper inter spacer distance. In certain embodiments, at least one of the spacers is inside the sample, at least two of the spacers inside the sample or the relevant volume of the sample, or at least of “n” spacers inside the sample or the relevant volume of the sample, where “n” is determined by a sample thickness uniformity or a required sample flow property during a QMAX.
Spacer height. In some embodiments, all spacers have the same pre-determined height. In some embodiments, spacers have different pre-determined heights. In some embodiments, spacers can be divided into groups or regions, wherein each group or region has its own spacer height. And in certain embodiments, the predetermined height of the spacers is an average height of the spacers. In some embodiments, the spacers have approximately the same height. In some embodiments, a percentage of number of the spacers have the same height.

The height of the spacers is selected by a desired regulated spacing between the plates and/or a regulated final sample thickness and the residue sample thickness. The spacer height (the predetermined spacer height), the spacing between the plates, and/or sample thickness is 3 nm or less, 10 nm or less, 50 nm or less, 100 nm or less, 200 nm or less, 500 nm or less, 800 nm or less, 1000 nm or less, 1 μm or less, 2 μm or less, 3 μm or less, 5 μm or less, 10 μm or less, 20 μm or less, 30 μm or less, 50 μm or less, 100 μm or less, 150 μm or less, 200 μm or less, 300 μm or less, 500 μm or less, 800 μm or less, 1 mm or less, 2 mm or less, 4 mm or less, or in a range between any two of the values.

The spacer height, the spacing between the plates, and/or sample thickness is between 1 nm to 100 nm in one preferred embodiment, 100 nm to 500 nm in another preferred embodiment, 500 nm to 1000 nm in a separate preferred embodiment, 1 μm (i.e. 1000 nm) to 2 μm in another preferred embodiment, 2 μm to 3 μm in a separate preferred embodiment, 3 μm to 5 μm in another preferred embodiment, 5 μm to 10 μm in a separate preferred embodiment, and 10 μm to 50 μm in another preferred embodiment, 50 μm to 100 μm in a separate preferred embodiment.

In some embodiments, the spacer height is controlled precisely. The relative precision of the spacer (i.e. the ratio of the deviation to the desired spacer height) is 0.001% or less, 0.01% or less, 0.1% or less; 0.5% or less, 1% or less, 2% or less, 5% or less, 8% or less, 10% or less, 15% or less, 20% or less, 30% or less, 40% or less, 50% or less, 60% or less, 70% or less, 80% or less, 90% or less, 99.9% or less, or a range between any of the values.

In some embodiments, the spacer height, the spacing between the plates, and/or sample thickness is: (i) equal to or slightly larger than the minimum dimension of an analyte, or (ii) equal to or slightly larger than the maximum dimension of an analyte. The “slightly larger” means that it is about 1% to 5% larger and any number between the two values.

In some embodiments, the spacer height, the spacing between the plates, and/or sample thickness is larger than the minimum dimension of an analyte (e.g. an analyte has an anisotropic shape), but less than the maximum dimension of the analyte.

For example, the red blood cell has a disk shape with a minim dimension of 2 μm (disk thickness) and a maximum dimension of 11 μm (a disk diameter). In an embodiment of the present invention, the spacers are selected to make the inner surface spacing of the plates in a relevant area to be 2 μm (equal to the minimum dimension) in one embodiment, 2.2 μm in another embodiment, or 3 (50% larger than the minimum dimension) in other embodiment, but less than the maximum dimension of the red blood cell. Such embodiment has certain advantages in blood cell counting. In one embodiment, for red blood cell counting, by making the inner surface spacing at 2 or 3 μm and any number between the two values, an undiluted whole blood sample is confined in the spacing; on average, each red blood cell (RBC) does not overlap with others, allowing an accurate counting of the red blood cells visually. (Too many overlaps between the RBC's can cause serious errors in counting).

In some embodiments, the spacer height, the spacing between the plates, and/or sample thickness is: (i) equal to or smaller than the minimum dimension of an analyte, or (ii) equal to or slightly smaller than the maximum dimension of an analyte. The “slightly smaller” means that it is about 1% to 5% smaller and any number between the two values.

In some embodiments, the spacer height, the spacing between the plates, and/or sample thickness is larger than the minimum dimension of an analyte (e.g. an analyte has an anisotropic shape), but less than the maximum dimension of the analyte.

In the present invention, in some embodiments, the plates and the spacers are used to regulate not only the thickness of a sample, but also the orientation and/or surface density of the analytes/entity in the sample when the plates are at the closed configuration. When the plates are at a closed configuration, a thinner thickness of the sample results in less analytes/entity per surface area (i.e. less surface concentration).
Spacer lateral dimension. For an open-spacer, the lateral dimensions can be characterized by its lateral dimension (sometimes called width) in the x and y—two orthogonal directions. The lateral dimension of a spacer in each direction is the same or different. In some embodiments, the lateral dimension for each direction (x or y) is 1 nm or less, 3 nm or less, 5 nm or less, 7 nm or less, 10 nm or less, 20 nm or less, 30 nm or less, 40 nm or less, 50 nm or less, 100 nm or less, 200 nm or less, 500 nm or less, 800 nm or less, 1000 nm or less, 1 μm or less, 2 μm or less, 3 μm or less, 5 μm or less, 10 μm or less, 20 μm or less, 30 μm or less, 50 μm or less, 100 μm or less, 150 μm or less, 200 μm or less, 300 μm or less, or 500 μm or less, or in a range between any two of the values.

In some embodiments, the ratio of the lateral dimensions of x to y direction is 1, 1.5, 2, 5, 10, 100, 500, 1000, 10,000, or a range between any two of the value. In some embodiments, a different ratio is used to regulate the sample flow direction; the larger the ratio, the flow is along one direction (larger size direction).

In some embodiments, different lateral dimensions of the spacers in x and y direction are used as (a) using the spacers as scale-markers to indicate the orientation of the plates, (b) using the spacers to create more sample flow in a preferred direction, or both.

In a preferred embodiment, the period, width, and height of the spacers are substantially the same. In some embodiments, all spacers have the same shape and dimensions. In some embodiments, the spacers have different lateral dimensions.

For enclosed-spacers, in some embodiments, the inner lateral shape and size are selected based on the total volume of a sample to be enclosed by the enclosed spacer(s), wherein the volume size has been described in the present disclosure; and in certain embodiments, the outer lateral shape and size are selected based on the needed strength to support the pressure of the liquid against the spacer and the compress pressure that presses the plates.

In certain embodiments, the aspect ratio of the height to the average lateral dimension of the pillar spacer is 100,000, 10,000, 1,000, 100, 10, 1, 0.1, 0.01, 0.001, 0.0001, 0, 00001, or in a range between any two of the values.
Inter-spacer distance. The spacers can be a single spacer or a plurality of spacers on the plate or in a relevant area of the sample. In some embodiments, the spacers on the plates are configured and/or arranged in an array form, and the array is a periodic, non-periodic array or periodic in some locations of the plate while non-periodic in other locations.

In some embodiments, the periodic array of the spacers is arranged as lattices of square, rectangle, triangle, hexagon, polygon, or any combinations of thereof, where a combination means that different locations of a plate has different spacer lattices.

In some embodiments, the inter-spacer distance of a spacer array is periodic (i.e. uniform inter-spacer distance) in at least one direction of the array. In some embodiments, the inter-spacer distance is configured to improve the uniformity between the plate spacing at a closed configuration.

In some embodiments, the distance between neighboring spacers (i.e. the inter-spacer distance) is 1 μm or less, 5 μm or less, 7 μm or less, 10 μm or less, 20 μm or less, 30 μm or less, 40 μm or less, 50 μm or less, 60 μm or less, 70 μm or less, 80 μm or less, 90 μm or less, 100 μm or less, 200 μm or less, 300 μm or less, 400 μm or less, or in a range between any two of the values.

In certain embodiments, the inter-spacer distance is at 400 μm or less, 500 μm or less, 1 mm or less, 2 mm or less, 3 mm or less, 5 mm or less, 7 mm or less, 10 mm or less, or in any range between the values. In certain embodiments, the inter-spacer distance is a 10 mm or less, 20 mm or less, 30 mm or less, 50 mm or less, 70 mm or less, 100 mm or less, or in any range between the values.

The distance between neighboring spacers (i.e. the inter-spacer distance) is selected so that for a given properties of the plates and a sample, at the closed-configuration of the plates, the sample thickness variation between two neighboring spacers is, in some embodiments, at most 0.5%, 1%, 5%, 10%, 20%, 30%, 50%, 80%, or in any range between the values; or in certain embodiments, at most 80%, 100%, 200%, 400%, or in a range between any two of the values.

Clearly, for maintaining a given sample thickness variation between two neighboring spacers, when a more flexible plate is used, a closer inter-spacer distance is needed.

In a preferred embodiment, the spacer is a periodic square array, wherein the spacer is a pillar that has a height of 2 to 4 μm, an average lateral dimension of from 1 to 20 μm, and inter-spacer spacing of 1 μm to 100 μm.

In a preferred embodiment, the spacer is a periodic square array, wherein the spacer is a pillar that has a height of 2 to 4 μm, an average lateral dimension of from 1 to 20 μm, and inter-spacer spacing of 100 μm to 250 μm.

In a preferred embodiment, the spacer is a periodic square array, wherein the spacer is a pillar that has a height of 4 to 50 μm, an average lateral dimension of from 1 to 20 μm, and inter-spacer spacing of 1 μm to 100 μm.

In a preferred embodiment, the spacer is a periodic square array, wherein the spacer is a pillar that has a height of 4 to 50 μm, an average lateral dimension of from 1 to 20 μm, and inter-spacer spacing of 100 μm to 250 μm.

The period of spacer array is between 1 nm to 100 nm in one preferred embodiment, 100 nm to 500 nm in another preferred embodiment, 500 nm to 1000 nm in a separate preferred embodiment, 1 μm (i.e. 1000 nm) to 2 μm in another preferred embodiment, 2 μm to 3 μm in a separate preferred embodiment, 3 μm to 5 μm in another preferred embodiment, 5 μm to 10 μm in a separate preferred embodiment, and 10 μm to 50 μm in another preferred embodiment, 50 μm to 100 μm in a separate preferred embodiment, 100 μm to 175 μm in a separate preferred embodiment, and 175 μm to 300 μm in a separate preferred embodiment.
Spacer density. The spacers are arranged on the respective plates at a surface density of greater than one per μm², greater than one per 10 μm², greater than one per 100 μm², greater than one per 500 μm², greater than one per 1000 μm², greater than one per 5000 μm², greater than one per 0.01 mm², greater than one per 0.1 mm², greater than one per 1 mm², greater than one per 5 mm², greater than one per 10 mm², greater than one per 100 mm², greater than one per 1000 mm², greater than one per 10000 mm², or in a range between any two of the values. In some embodiments, the spacers have a density of at least 1/mm², at least 10/mm², at least 50/mm², at least 100/mm², at least 1,000/mm², or at least 10,000/mm². In some embodiments, the spacers are periodic.

Spacer area filling factor is defined as the ratio of spacer area to the total area or the ratio of spacer period to the width. In some embodiments, the filling factor is at least 1%, 2%, 3%, 4%, 5%, 6%, 7%, 8%, 9%, 10%, 20%, or in the range between any of the two values. In certain embodiments, the filling factor is at least 2.3%.
Ratio of spacer volume to sample volume. In many embodiments, the ratio of the spacer volume (i.e. the volume of the spacer) to sample volume (i.e. the volume of the sample), and/or the ratio of the volume of the spacers that are inside of the relevant volume of the sample to the relevant volume of the sample are controlled for achieving certain advantages. The advantages include, but not limited to, the uniformity of the sample thickness control, the uniformity of analytes, the sample flow properties (i.e. flow speed, flow direction, etc.).

In some embodiments, the spacers are configured to not take significant surface area (volume) in a given sample area (volume).

In certain embodiments, the ratio of the spacer volume r) to sample volume, and/or the ratio of the volume of the spacers that are inside of the relevant volume of the sample to the relevant volume of the sample is less than 100%, at most 99%, at most 90%, at most 70%, at most 50%, at most 30%, at most 10%, at most 5%, at most 3% at most 1%, at most 0.1%, at most 0.01%, at most 0.001%, or in a range between any of the values.
Spacers fixed to plates. The inter spacer distance and the orientation of the spacers, which play a key role in the present invention, are preferably maintained during the process of bringing the plates from an open configuration to the closed configuration, and/or are preferably predetermined before the process from an open configuration to a closed configuration.

In some embodiments of the present invention, the spacers are fixed on one of the plates before bringing the plates to the closed configuration. The term “a spacer is fixed with its respective plate” means that the spacer is attached to a plate and the attachment is maintained during a use of the plate. An example of “a spacer is fixed with its respective plate” is that a spacer is monolithically made of one piece of material of the plate, and the position of the spacer relative to the plate surface does not change. An example of “a spacer is not fixed with its respective plate” is that a spacer is glued to a plate by an adhesive, but during a use of the plate, the adhesive cannot hold the spacer at its original location on the plate surface (i.e. the spacer moves away from its original position on the plate surface).

In some embodiments, at least one of the spacers are fixed to its respective plate. In certain embodiments, at two spacers are fixed to its respective plates. In certain embodiments, a majority of the spacers are fixed with their respective plates. In certain embodiments, all of the spacers are fixed with their respective plates.

In some embodiments, a spacer is fixed to a plate monolithically.

In some embodiments, the spacers are fixed to its respective plate by one or any combination of the following methods and/or configurations: attached to, bonded to, fused to, imprinted, and etched.

The term “imprinted” means that a spacer and a plate are fixed monolithically by imprinting (i.e. embossing) a piece of a material to form the spacer on the plate surface. The material can be single layer of a material or multiple layers of the material.

The term “etched” means that a spacer and a plate are fixed monolithically by etching a piece of a material to form the spacer on the plate surface. The material can be single layer of a material or multiple layers of the material.

The term “fused to” means that a spacer and a plate are fixed monolithically by attaching a spacer and a plate together, the original materials for the spacer and the plate fused into each other, and there is clear material boundary between the two materials after the fusion.

The term “bonded to” means that a spacer and a plate are fixed monolithically by binding a spacer and a plate by adhesion.

The term “attached to” means that a spacer and a plate are connected together.

In some embodiments, the spacers and the plate are made in the same materials. In other embodiment, the spacers and the plate are made from different materials. In other embodiment, the spacer and the plate are formed in one piece. In other embodiment, the spacer has one end fixed to its respective plate, while the end is open for accommodating different configurations of the two plates.

In other embodiment, each of the spacers independently is at least one of attached to, bonded to, fused to, imprinted in, and etched in the respective plate. The term “independently” means that one spacer is fixed with its respective plate by a same or a different method that is selected from the methods of attached to, bonded to, fused to, imprinted in, and etched in the respective plate.

In some embodiments, at least a distance between two spacers is predetermined (“predetermined inter-spacer distance” means that the distance is known when a user uses the plates.).

In some embodiments of all methods and devices described herein, there are additional spacers besides to the fixed spacers.
Sample. In the present invention of the methods and devices that use a QMAX process, the sample is deposited by one of several methods or a combination of the methods. In one embodiment of the deposition, the sample is deposited on only one plate. In certain embodiments, the sample is deposited on both plates (i.e. the first and the second plate).

The sample is deposited when the plates are at an open configuration. In some embodiments, the deposition of the sample can be a single drop or multiple drops. The multiple drops can be at one location or multiple locations of either one plate or both plates. The droplets can be well separated from each other, connected, or a combination of thereof.

In some embodiments, a sample comprises more than one materials, and the materials are deposited together or separately. The materials are deposited separately either in parallel or sequence.

The deposition of the sample to the plates (i.e. the first plate and the second plate) can be performed using a device or directly from test subject to the plates. In some embodiments, a sample is deposited using a device. The device includes, but is not limited to, pipettes, needle, stick, swab, tube, jet, liquid dispenser, tips, stick, inkjets, printers, spraying devices, etc. In certain embodiments, a sample is deposited by a direct contacting between the sample at the sample source and a QMAX plate without using any devices (i.e. bring the sample and the plate together to make a contact between the two). This is termed “direct sample deposition”.

Examples of a direct sample deposition of a sample to a plate(s) are (a) a direct contact of between pricked finger (or other body parts) and a plate, (b) spitting saliva onto the plate(s), (c) taking a tear in human eyes by a direct contact between the tear and the plate(s), (d) a direct contact between the sweat and the plate(s), and (e) a direct breathing onto the plate(s) to deposit a breath, etc. Such direct deposition method can be used for both human and animals.

In some embodiments, both a direct and indirect (through a device) sample deposition are used.

In present invention, the volume of the sample that is deposited on the plate or the plates (“sample volume”) is at most 0.001 pL (pico liter), at most 0.01 pL, at most 0.1 pL, at most 1 pL, at most 10 pL, at most 100 pL, at most 1 nL (nano liter), at most 10 nL, at most 100 nL, at most 1 uL (micro liter), at most 10 uL, at most 100 uL, at most 1 mL (milliliter), at most 10 mL, or in a range of any two of these values.

In some embodiments, the depositing of a sample comprises the steps of (a) putting a sample on one or both of the plates, and (b) spreading the sample using a means other than the second plate compression in a QMAX process. The means of spreading the sample include using another device (e.g. stick, blade), air blow, or others.
Sample Deformation. During a QMAX process, in some embodiments, the samples behave approximately like an incompressible liquid (which refers to a liquid that maintains a constant volume under a shape deformation), therefore a change in the sample thickness would lead to the change in the sample area. In some embodiments, the samples behave like a compressible liquid, yet their lateral area still expand when their thickness is reduced during a QMAX process. In certain embodiments, the sample are liquid, gel, or soft-solids, as long as that, during a QMAX process, their lateral area expands when their thickness is reduced.

In the of the present invention disclosed, “facing the first plate and the second plate” is a process that manipulates the position and orientation of the first plate or the second plate or both, so that the sample is between the inner surfaces of the first plate and the second plate. In some embodiments, the action of “facing the first plate and the second plate” is performed by human hands, human hands with certain devices, or automatic devices without human hands.

In some embodiments, the thickness is at most 1 mm, at most 100 μm, at most 20 μm, at most 10 μm, or at most 2 μm. In some embodiments, the thickness is at least 0.1 μm. In some embodiments, further comprising measuring the thickness.

In some embodiments, a variation of the thickness of the relevant volume of the sample is at most 300%, at most 100%, at most 30%, at most 10%, at most 3%, at most 1%, at most 0.3%, or at most 0.1% of an effective diameter of the relevant area

In some embodiments, the thickness is at least partially determined by the predetermined height.

The QMAX is pressed by hands.
Final Sample Thickness. The final sample thickness at the closed configuration of the plates are a significant factor in reducing the saturation incubation time. The final sample thickness after the sample thickness reduction/deformation, depending upon the properties of entity and samples as well as the applications, as discussed with respect to the regulated spacing of the plates.

In some embodiments, The final sample thickness is less than about 0.5 μm (micrometer), less than about 1 μm, less than about 1.5 μm, less than about 2 μm, less than about 4 μm, less than about 6 μm, less than about 8 μm, less than about 10 μm, less than about 12 μm, less than about 14 μm, less than about 16 μm, less than about 18 μm, less than about 20 μm, less than about 25 μm, less than about 30 μm, less than about 35 μm, less than about 40 μm, less than about 45 μm, less than about 50 μm, less than about 55 μm, less than about 60 μm, less than about 70 μm, less than about 80 μm, less than about 90 μm, less than about 100 μm, less than about 110 μm, less than about 120 μm, less than about 140 μm, less than about 160 μm, less than about 180 μm, less than about 200 μm, less than about 250 μm, less than about 300 μm, less than about 350 μm, less than about 400 μm, less than about 450 μm, less than about 500 μm, less than about 550 μm, less than about 600 μm, less than about 650 μm, less than about 700 μm, less than about 800 μm, less than about 900 μm, less than about 1000 μm (1 mm), less than about 1.5 mm, less than about 2 mm, less than about 2.5 mm, less than about 3 mm, less than about 3.5 mm, less than about 4 mm, less than about 5 mm, less than about 6 mm, less than about 7 mm, less than about 8 mm, less than about 9 mm, less than about 10 mm, or in a range between any two of the values.

In certain embodiments, the final sample thickness at the closed configuration is substantially the same as the uniform height of the spacers and is less than 0.5 μm (micron), less than 1 μm, less than 5 μm, less than 10 μm, less than 20 μm, less than 30 μm, less than 50 μm, less than 100 μm, less than 200 μm, less than 300 μm, less than 500 μm, less than 800 μm, less than 200 μm, less than 1 mm (millimeter), less than 2 mm (millimeter), less than 4 mm (millimeter), less than 8 mm (millimeter), or in a range between any two of the values.

In the present invention, it was observed that a larger plate holding force (i.e. the force that holds the two plates together) can be achieved by using a smaller plate spacing (for a given sample area), or a larger sample area (for a given plate-spacing), or both.

In some embodiments, at least one of the plates is transparent in a region encompassing the relevant area, each plate has an inner surface configured to contact the sample in the closed configuration; the inner surfaces of the plates are substantially parallel with each other, in the closed configuration; the inner surfaces of the plates are substantially planar, except the locations that have the spacers; or any combination of thereof.
Final Sample Thickness and Uniformity. In some embodiments, the sample in the closed configuration is significantly flat, which is determined relative to the final sample thickness, and has, depending upon on embodiments and applications, a ratio to the sample thickness of less than 0.1%, less than 0.5%, less than 1%, less than 2%, less than 5%, or less than 10%, or in a range between any two of these values.

In some embodiments, flatness relative to the sample thickness is less than 0.1%, less than 0.5%, less than 1%, less than 2%, less than 5%, less than 10%, less than 20%, less than 50%, or less than 100%, or a range between any two of these values.

In some embodiments, significantly flat means that the surface flatness variation itself (measured from an average thickness) is less than 0.1%, less than 0.5%, less than 1%, less than 2%, less than 5%, or less than 10%, or a range between any two of these values. Generally, flatness relative to the plate thickness is less than 0.1%, less than 0.5%, less than 1%, less than 2%, less than 5%, less than 10%, less than 20%, less than 50%, or less than 100%, or a range between any two of these values.

### 23. Related Documents

In some embodiments, the QMAX card of the present invention includes , but not limited to, the embodiments described in U.S. Provisional Patent Application No. 62/202,989, which was filed on Aug. 10, 2015, U.S. Provisional Patent Application No. 62/218,455, which was filed on Sep. 14, 2015, U.S. Provisional Patent Application No. 62/293,188, which was filed on Feb. 9, 2016, U.S. Provisional Patent Application No. 62/305,123, which was filed on Mar. 8, 2016, U.S. Provisional Patent Application No. 62/369,181, which was filed on Jul. 31, 2016, U.S. Provisional Patent Application No. 62/394,753, which was filed on Sep. 15, 2016, PCT Application (designating U.S.) No. PCT/US2016/045437, which was filed on Aug. 10, 2016, PCT Application (designating U.S.) No. PCT/US2016/051775, which was filed on Sep. 14, 2016, PCT Application (designating U.S.) No. PCT/US2016/051794, which was filed on Sep. 15, 2016, and PCT Application (designating U.S.) No. PCT/US2016/054025, which was filed on Sep. 27, 2016; all of these disclosures are hereby incorporated by reference for their entirety and for all purposes.

The devices and methods herein disclosed have various types of biological/chemical sampling, sensing, assays and applications, which include, but not limited to, those described in PCT Application (designating U.S.) No. PCT/US2016/045437, which was filed on Aug. 10, 2016, and PCT/US16/51794, which was filed on Sep. 14, 2016; are hereby incorporated by reference by its entirety.

The devices and methods herein disclosed is used for samples such as but not limited to diagnostic sample, clinical sample, environmental sample and foodstuff sample. The types of sample include but are not limited to the samples listed, described and summarized in PCT Application (designating U.S.) No. PCT/US2016/045437, which was filed on Aug. 10, 2016, and is hereby incorporated by reference by its entirety.

The devices and methods herein disclosed are used for the detection, purification and/or quantification of analytes such as but not limited to biomarkers. Examples of the biomarkers include but not be limited to what is listed, described and summarized in PCT Application (designating U.S.) No. PCT/US2016/045437, which was filed on Aug. 10, 2016, and is hereby incorporated by reference by its entirety.

The devices and methods herein disclosed are used with the facilitation and enhancement of mobile communication devices and systems, which include devices and systems listed, described and summarized in PCT Application (designating U.S.) No. PCT/US2016/045437, which was filed on Aug. 10, 2016, and is hereby incorporated by reference by its entirety.

The present invention includes a variety of embodiments, which can be combined in multiple ways as long as the various components do not contradict one another. The embodiments should be regarded as a single invention file: each filing has other filing as the references and is also referenced in its entirety and for all purpose, rather than as a discrete independent. These embodiments include not only the disclosures in the current file, but also the documents that are herein referenced, incorporated, or to which priority is claimed.

(1) Definitions

The terms used in describing the devices, systems, and methods herein disclosed are defined in the current application, or in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

The terms “CROF Card (or card)”, “COF Card”, “QMAX-Card”, “Q-Card”, “CROF device”, “COF device”, “QMAX-device”, “CROF plates”, “COF plates”, and “QMAX-plates” are interchangeable, except that in some embodiments, the COF card does not comprise spacers; and the terms refer to a device that comprises a first plate and a second plate that are movable relative to each other into different configurations (including an open configuration and a closed configuration), and that comprises spacers (except some embodiments of the COF card) that regulate the spacing between the plates. The term “X-plate” refers to one of the two plates in a CROF card, wherein the spacers are fixed to this plate. More descriptions of the COF Card, CROF Card, and X-plate are given in the provisional application Ser. No. 62/456,065, filed on Feb. 7, 2017, which is incorporated herein in its entirety for all purposes.

(2) Q-Card, Spacer and Uniform Sample Thickness

The devices, systems, and methods herein disclosed can include or use Q-cards, spacers, and uniform sample thickness embodiments for sample detection, analysis, and quantification. In some embodiments, the Q-card comprises spacers, which help to render at least part of the sample into a layer of high uniformity. The structure, material, function, variation and dimension of the spacers, as well as the uniformity of the spacers and the sample layer, are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(3) Hinges, Opening Notches, Recessed Edge and Sliders

The devices, systems, and methods herein disclosed can include or use Q-cards for sample detection, analysis, and quantification. In some embodiments, the Q-card comprises hinges, notches, recesses, and sliders, which help to facilitate the manipulation of the Q card and the measurement of the samples. The structure, material, function, variation and dimension of the hinges, notches, recesses, and sliders are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(4) Q-Card, Sliders, and Smartphone Detection System

The devices, systems, and methods herein disclosed can include or use Q-cards for sample detection, analysis, and quantification. In some embodiments, the Q-cards are used together with sliders that allow the card to be read by a smartphone detection system. The structure, material, function, variation, dimension and connection of the Q-card, the sliders, and the smartphone detection system are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(5) Detection Methods

The devices, systems, and methods herein disclosed can include or be used in various types of detection methods. The detection methods are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(6) Labels

The devices, systems, and methods herein disclosed can employ various types of labels that are used for analytes detection. The labels are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(7) Analytes

The devices, systems, and methods herein disclosed can be applied to manipulation and detection of various types of analytes (including biomarkers). The analytes and are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(8) Applications (Field and Samples)

The devices, systems, and methods herein disclosed can be used for various applications (fields and samples). The applications are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

(9) Cloud

The devices, systems, and methods herein disclosed can employ cloud technology for data transfer, storage, and/or analysis. The related cloud technologies are herein disclosed, or listed, described, and summarized in PCT Application (designating U.S.) Nos. PCT/US2016/045437 and PCT/US0216/051775, which were respectively filed on Aug. 10, 2016 and Sep. 14, 2016, U.S. Provisional Application No. 62/456,065, which was filed on Feb. 7, 2017, all of which applications are incorporated herein in their entireties for all purposes.

### Additional Notes

Further examples of inventive subject matter according to the present disclosure are described in the following enumerated embodiments.

It must be noted that as used herein and in the appended claims, the singular forms “a”, “an”, and “the” include plural referents unless the context clearly dictates otherwise, e.g., when the word “single” is used. For example, reference to “an analyte” includes a single analyte and multiple analytes, reference to “a capture agent” includes a single capture agent and multiple capture agents, reference to “a detection agent” includes a single detection agent and multiple detection agents, and reference to “an agent” includes a single agent and multiple agents.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function. Similarly, subject matter that is recited as being configured to perform a particular function may additionally or alternatively be described as being operative to perform that function.

As used herein, the phrase, “for example,” the phrase, “as an example,” and/or simply the terms “example” and “exemplary” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the phrases “at least one of” and “one or more of,” in reference to a list of more than one entity, means any one or more of the entity in the list of entity, and is not limited to at least one of each and every entity specifically listed within the list of entity. For example, “at least one of A and B” (or, equivalently, “at least one of A or B,” or, equivalently, “at least one of A and/or B”) may refer to A alone, B alone, or the combination of A and B.

As used herein, the term “and/or” placed between a first entity and a second entity means one of (1) the first entity, (2) the second entity, and (3) the first entity and the second entity. Multiple entity listed with “and/or” should be construed in the same manner, i.e., “one or more” of the entity so conjoined. Other entity may optionally be present other than the entity specifically identified by the “and/or” clause, whether related or unrelated to those entities specifically identified.

Where numerical ranges are mentioned herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, unless otherwise indicated or otherwise evident from the context and understanding of one of ordinary skill in the art.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

1.-149. (canceled)

150. A device for sample analysis, comprising:
a first plate, a second plate, spacers, a hinge, and an adhesive, wherein:
i. the first plate and the second plate are connected by the hinge and movable relative to each other around the axis of the hinge into different configurations, including an open configuration and a closed configuration;
ii. each plate comprises an inner surface that has a sample contact area for contacting a sample for analysis;
iii. the first plate has a notch on an edge or a corner of the plate;
iv. in the closed configuration, a portion of an edge of the second plate is disposed over the notch, such that the second plate can be separated from first plate and lifted into the open configuration without interference by the first plate;
v. in the closed configuration, at least two edges of the second plate, except the portion of the edge of the second plate that is disposed over the notch, are recessed inside the edges of the first plate;
vi. the adhesive is disposed on the edge of the plates, such that when in the closed configuration, the second plate adheres to first plate via the adhesive;
vii. the spacers are on one or both plates and have a height of 200 um or less, wherein at least a part of the spacers are in the sample contact area; and
wherein in the open configuration, the two plates are partially or entirely separated apart, wherein the sample is deposited in the open configuration, and wherein in the closed configuration, the spacing between the plates are regulated by the spacers.

151. The device of claim 1, wherein the second plate is configured to have, in the closed configuration, all edges of the second plate, except the portion of the edge of the second plate that is disposed over the notch and except the edge with hinge are recessed inside of the edges of the first plate, wherein the hinged edge is either recessed or not recessed from the corresponding edge of the first plate.

152. The device of claim 1, wherein the hinge is made of thin film and an angle self-maintaining (ASM) hinge.

153. An apparatus comprising:
(a) the device of claim 1; and
(b) an adaptor that is configured to connect to a camera and comprises a slot, wherein:
i. the slot is dimensioned to receive the device in the closed configuration;
ii. the slot is configured to allow the device slide in and out of the slot; and
iii. the device is viewed by the camera.

154. A method of sample analysis, comprising:
obtaining the device of claim 1;
depositing the sample on the inner surface of one or both of the plates when the plates are at an open configuration;
turning the plates around the axis of the hinge into a closed configuration; and
analyzing the sample at the closed configuration.

155. A method of sample analysis, comprising
obtaining the device of claim 1;
depositing a sample on one or both of the sample contact areas of the device when the plates are configured in an open configuration;
moving, after depositing the sample, the two plates around the hinge into the closed configuration, wherein, in the closed configuration, at least part of the sample is compressed into a thin layer between the plates;
imaging, using a camera, one or more images of the sample; and
analyzing the sample by analyzing the images.

156. The method of claim 155, further comprising using the spacers as scale markers in analyzing the sample.

157. The device of claim 1, wherein the adhesive is removably attachable to the plate.

158. The device of claim 1, wherein the adhesive is peelable off the plate.

159. The device of claim 1, wherein the adhesive is pressure sensitive.

160. The device of claim 1, wherein the adhesive is selected from the group consisting of glue, cement, mucilage, or paste.

161. The device of claim 1, wherein the adhesive is an adhesive strip.

162. The device of claim 1, wherein the adhesive has a thickness that is less than or equal to the height of the spacers.

163. The device of claim 1, wherein the adhesive has a thickness that is larger than the height of the spacers.

164. The device of claim 1, wherein one of the plates has a thickness of 200 μm or less.

165. The device of claim 1, wherein the adhesive is disposed on the edge opposite the edge with the hinge.

166. The device of claim 1, wherein the spacers have a height selected from 05 um to 100 um.

167. The device of claim 1, wherein the hinge is an angle self-maintaining hinge.

168. The method of claim 154, further comprising:
analyzing the sample by imaging the sample with an imager or detecting a measurable signal from the sample.

169. The method of claim 168, wherein the imager is the camera of a handheld mobile communication device.
